(19) United States
(12) Patent Application Publication
(10) Pub. No.: US 2004/0043900 A1
(43) Pub. Date: Mar. 4, 2004

(54) Heterogeneous gaseous chemical reactor catalyst

(76) Inventor: Glenn A. Combs, Monroe, LA (US)

Correspondence Address: Richard C. Litman, LITMAN LAW OFFICES, LTD., P.O. Box 15035, Arlington, VA, 22215, US

(21) Appl. No.: 10/636,784

(22) Filed: Aug. 8, 2003

Related U.S. Application Data
(60) Provisional application No. 60/402,580, filed on Aug. 12, 2002.

(51) Int. Cl. B01J 35/04

(52) U.S. Cl. 502/439; 502/527.19; 502/527.24

(57) ABSTRACT

An improved heterogeneous catalyst for catalyzing the reaction of gaseous reactants, comprising a high performance catalyst particle with a diameter to height ratio in the range between about 0.5:1 to 1.0:1.0, the high performance catalyst particle has a Relative Particle Size Parameter (RPSP) and a Geometric Surface Area (GSA), wherein the high performance catalyst particle has a higher GSA for a particular RPSP than a prior art catalyst particle. In another embodiment the improved heterogeneous catalyst with a diameter to height ratio in the range between about 0.5:1 to 1.0:1.0 has a Relative Particle Size Parameter (RPSP), a Geometric Surface Area (GSA), and an associated Relative Pressure Drop (RPD), wherein the high performance catalyst particle has a higher GSA for a particular RPSP or alternately a lower RPD for a particular GSA than a prior art catalyst particle.

### CROSS-REFERENCE TO RELATED APPLICATION

This application claims the benefit of U.S. Provisional Patent Application Serial No. 60/402,580, filed Aug. 12, 2002.

### 1. FIELD OF THE INVENTION

The present invention is directed to advanced catalyst shapes that increase catalyst performance while reducing gas pressure drop.

### 2. BACKGROUND OF THE INVENTION

Catalysts are employed in chemical reactors to promote the conversion of reactants to desired products. Good catalysts induce rapid transformation of chemical molecules to combine into different molecules while the catalyst itself is not expended or altered.

A catalyst that exists in a different phase as the chemical reactants is called a heterogeneous catalyst such as a solid catalyst used to transform gaseous reactant molecules to a useful gaseous product such as hydrogen. A heterogeneous catalyst system comprises a plurality of heterogeneous catalyst particles. Each heterogeneous catalyst particle typically comprises internal voids such as holes that travel the length of the particles to define apertures at both ends of the catalyst particle; external voids also form between catalyst particles when the particles are packed into, for example, a hollow tube. The gaseous reactants flow through the voids. Inefficient fluid flow can result in undesirable fluid friction losses. Heterogeneous catalyst research is focused on minimizing fluid friction losses while maximizing the conversion of gaseous reactants into desired reaction products.

“Hydrocarbon Reforming” is a term used to describe the process by which a heterogeneous catalyst converts hydrocarbons into hydrogen (and carbon monoxide). The generated hydrogen is used, for example, in the industrial manufacture of ammonia and methanol. In Hydrocarbon Reforming processes, hydrocarbons such as methane, and/or heavier hydrocarbon molecules, are combined with steam or carbon dioxide and reacted across a plurality of heterogeneous catalyst particles. The heterogeneous catalyst particles are typically packed inside the hollow bores of heated tubes or within pressure vessels, operating at 900-2400 degrees Fahrenheit and pressures from about 10 to 50 atmospheres.

Competing simultaneous Hydrocarbon Reforming and Water-Gas-Shift reactions occur on the active sites of the catalyst, as follows:

Steam-Hydrocarbon Reforming Reactions:

CH₄+H₂O=CO+3H₂ (+49.2 kcal/mole)

C₂H₆+2H₂O=2CO+5H₂

C₃H₈+3H₂O=3CO+7H₂ . . . and similarly for higher hydrocarbon reactants.

For Hydrogen Production by Reaction with CO₂:

CH₄+CO₂=2CO+2H₂

C₂H₆+2CO₂=4CO+3H₂

C₃H₈+3CO₂=6CO+4H₂ . . . and similarly for higher hydrocarbon reactants.

Water-Gas-Shift Reaction:

CO+H₂O=CO₂+H₂ (−9.84 kcal/mole)

Steam-Hydrocarbon and Carbon Dioxide-Hydrocarbon Reforming reactions are highly endothermic (i.e., require input of energy) and hydrogen production is best achieved by external heating of the gaseous reactant mixture in the presence of heterogeneous catalyst particles.

The Water-Gas-Shift reaction is exothermic (i.e., releases energy in the form of heat energy). Hydrocarbons heavier than methane are cracked catalytically to olefins and methane and then react further with steam yielding a gaseous product comprising a mixture of gases such as hydrogen, carbon monoxide, carbon dioxide and inert gases (e.g., nitrogen, helium and argon that are normally present in natural gas).

The chemical kinetics of the hydrocarbon reforming reaction is strongly influenced by the amount of catalytic surface area (referred to as geometric surface area (GSA) available to reactants on the heterogeneous catalyst particle. Specifically, the catalysis rate is limited by the diffusion rate of the gaseous reagents in the catalyst elements (see U.S. Pat. No. 4,089,941 issued May 16, 1978 to B. Villemin, column 1, and lines 49-60). Efforts have concentrated on increasing the contact area between the gaseous reagents and the catalyst. Decreasing the size of the catalyst elements increases the geometric surface area (GSA) of the catalyst. However, increasing the GSA can lead to a pressure drop penalty that deleteriously affects the synthesis of hydrogen (and carbon monoxide).

In auto-thermal reforming high temperature air or oxygen enriched air can be added to gas mixtures containing the reaction products from previous hydrocarbon reforming catalytic steps to produce higher levels of hydrogen and lower concentrations of hydrocarbon reactants such as methane. Auto-thermal reforming maximizes conversion of reactant hydrocarbons into desired hydrogen and carbon monoxide-carbon dioxide reaction products.

A key indicator of reforming catalyst performance is the extent of conversion of methane into hydrogen product, or the methane content in catalyst exit gases (“methane leakage”) for specific reactor temperature, pressure and gas throughput. Increasing the operating temperature reduces the amount of methane content in the exit gases.

In practical operation, the methane content in the exit gas from reforming catalyst is greater than the theoretical equilibrium value at a given temperature such that there is a lower equilibrium temperature where the observed higher methane composition would exist at equilibrium. This difference in temperature is commonly referred to as the Methane Approach to equilibrium.

Catalyst size and shape also impact on reformer gas pressure losses and catalyst strength, which likewise influences practical useful catalyst life. For externally fired tubular arrangements of hydrocarbon reforming reactor equipment, catalyst activity is a direct indication of catalyst tube metal temperature at times throughout the life of a catalyst charge, apart from other influences of plant throughput and specific reformer operating conditions. In normal service as reforming catalyst ages, tube metal temperature increases for otherwise fixed operating conditions, due to the loss of available catalytic component surface area from thermal sintering of active catalytic component crystallites to gradual larger size. Thus catalyst tube metal temperature is a direct indicator of catalyst activity throughout catalyst life for tubular hydrocarbon reforming reactors.

A review of the prior art follows.

U.S. Pat. No. 2,408,164 issued Sep. 24, 1946 to A. L. Foster, describes the preparation of catalytic materials suitable for pressing into various catalyst shapes.

U.S. Pat. No. 4,089,941 issued May 16, 1978 to B. Villemin, describes an impregnated nickel catalyst for the steam reforming of gaseous hydrocarbons to produce hydrogen, comprising a support containing at least 98% of alumina, having the shape of a cylinder containing at least four partitions located in radial planes and in which the porosity ranges between 0.08 and 0.20 cm³/g, and 4 to 15% of nickel calculated as nickel oxide (NiO) with respect to the total weight of the catalyst, deposited by impregnation on the support.

U.S. Pat. No. 4,233,187 issued Nov. 11, 1980 to Atwood, et al., describes a catalyst for use in the steam-hydrocarbon reforming reaction. The '187 catalyst comprises a group VIII metal on a cylindrical ceramic support consisting essentially of alpha alumina and having a plurality of gas passages extending axially there through.

U.S. Pat. No. 4,328,130 issued May 4, 1982 to C. P. Kyan, describes a shaped catalyst. The '130 catalyst has substantially the shape of a cylinder having a plurality of longitudinal channels extending radially from the circumference of the cylinder defining protrusions there-between. The protrusions have a maximum width greater than the maximum width of the channels.

U.S. Pat. No. 4,337,178 issued Jun. 29, 1982 to Atwood, et al., describes a catalyst that comprises a normally cylindrical refractory support having gas passages communicating from end to end and oriented parallel to its axis and having gas passages in the shape of segments of circles (pie-shaped), square, hexagonal, circular, oval or sinusoidal. The exterior and interior surfaces of the '178 catalyst are coated with catalytic compositions. The length of the refractory support is significantly less than the diameter. A ratio of height to effective internal diameter (H:ID) of less than 4:1 for each gas passage provided greater catalytic effectiveness than H:ID ratios greater than 4. One difficulty with this catalyst shape is that it cannot be produced in small diameters as rings where the diameter to height ratio is substantially less than 1.5:1 to achieve higher geometric surface area or to lower pressure drop because the hole sizes become too small, rendering the catalyst difficult to manufacture.

U.S. Pat. No. 4,441,990 issued Apr. 10, 1984 to Yun-Yang Huang, describes various cross-section shapes applied to a catalytic particle. Examples of cross-section shapes are rectangular shaped tubes, and triangular shaped tubes. The catalyst particle has a non-cylindrical centrally located aperture surrounded by a solid wall portion, a volume to surface ratio of less than about 0.02 inch and an external periphery characterized by having at least three points of contact when circumscribed by a cylindrical shape. The '990 catalyst particles comprise of shapes with smaller geometric surface area than multi-holed axial cylindrical ring catalyst shapes of comparable catalyst size with a concomitant deleterious impact on catalyst activity.

U.S. Pat. No. 5,527,631 issued Jun. 18, 1996 to Singh et al., describes a catalyst support that defines at least one discrete passageway extending along the length of the non-rigid, porous, fibrous catalyst support forming a reformable gas flow channel in heat communication with means for heating the reformable hydrocarbon gas, wherein the catalyst impregnated on the catalyst support comprises Ni and MgO. Such a non-rigid, porous, fibrous catalyst would be difficult to produce in commercial quantities because of the small size and characteristic shape of the interior discrete flow channels.

None of the above inventions and patents, taken either singly or in combination, is seen to describe the instant invention as claimed. Thus, a catalyst and method of making thereof solving the aforementioned problems is desired.

### SUMMARY OF THE INVENTION

An improved heterogeneous catalyst for catalyzing the reaction of gaseous reactants, comprising a high performance catalyst particle with a diameter to height ratio in the range between about 0.5:1 to 1.0:1.0, the high performance catalyst particle has a Relative Particle Size Parameter (RPSP) and a Geometric Surface Area (GSA), wherein the high performance catalyst particle has a higher GSA for a particular RPSP than a prior art catalyst particle.

In another embodiment the improved heterogeneous catalyst with a diameter to height ratio in the range between about 0.5:1 to 1.0:1.0 has a Relative Particle Size Parameter (RPSP), a Geometric Surface Area (GSA), and an associated Relative Pressure Drop (RPD), wherein the high performance catalyst particle has a higher GSA for a particular RPSP or alternately a lower RPD for a particular GSA than a prior art catalyst particle.

In a further embodiment a cylindrical catalyst defines at least one axial hole with greater hole peripheral circumference than holes of circular or regular-polygon shapes of the prior art.

Accordingly, it is a principal object of the invention to provide an improved catalyst particle for catalyzing the reaction of gaseous reactants.

It is another object of the invention to provide an improved catalyst particle for catalyzing Hydrocarbon Reforming reactions.

It is a further object of the invention to provide a cylindrical catalyst for catalyzing the reaction of gaseous reactants.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 shows a perspective view of a segment of chemical reaction tube filled with a plurality of improved catalyst particles of the present invention.

FIG. 2 shows a cut-away view of the segment of chemical reaction tube of FIG. 1.

FIG. 3 shows separate perspective, top and bottom, and elevation views of a range of heterogeneous ring catalysts of the prior art.

FIG. 4 shows the relationship between Relative Pressure Drop and Relative Particle Size calculated for the prior art Catalysts A to E.

FIG. 5 is a graph of geometric surface area (GSA) verses the Relative Particle Size Parameter (RPSP) calculated for the prior art Catalysts A to E.

FIG. 6 is a graph of GSA verses RPSP for Raschig Ring catalyst shapes.

FIG. 6A shows a catalyst pressure-drop measuring apparatus.

FIG. 7 shows separate perspective, top and bottom, and elevation views of cylindrical catalysts with at least one internal pear-shaped hole according to the present invention.

FIG. 8 shows a graph of GSA v. RPSP of a cylindrical ring catalyst with five internal generally pear shaped holes according to the present invention.

FIG. 9 shows separate perspective, top and bottom, and elevation views of cylindrical catalysts with at least one internal generally elliptical shaped hole according to the present invention.

FIG. 10 shows a graph of GSA v. RPSP of a cylindrical ring catalyst with six internal generally elliptical shaped holes according to the present invention.

FIG. 11A shows separate perspective, top and bottom, and elevation views of cylindrical catalysts with at least one internal L-shaped hole according to the present invention.

FIG. 11B shows a detailed view of the internal L-shaped hole of FIG. 11A according to the present invention.

FIG. 12 shows a graph of GSA v. RPSP of the cylindrical ring catalyst with four internal generally L-shaped holes.

FIG. 13A shows separate perspective, top and bottom, and elevation views of cylindrical catalysts with at least one internal generally rounded-diamond-shaped hole according to the present invention.

FIG. 13B shows a top view of an internal rounded-diamond-shaped hole of FIG. 13A according to the present invention.

FIG. 14 shows a graph of GSA v. RPSP of the cylindrical ring catalyst with five internal generally rounded-diamond-shaped holes according to the present invention.

FIG. 15 shows separate perspective, top and bottom, and elevation views of cylindrical catalyst with at least one internal generally diamond-shaped hole according to the present invention.

FIG. 16 shows a graph of GSA v. RPSP of the cylindrical ring catalyst with five internal generally diamond-shaped holes according to the present invention.

FIG. 17A shows separate perspective, top and bottom, and elevation views of cylindrical catalyst with at least one internal generally slot-shaped hole according to the present invention.

FIG. 17B shows an internal asymmetric slot shaped hole according to the present invention.

FIG. 18 shows a graph of GSA v. RPSP of the cylindrical ring catalyst with six internal generally slot-shaped holes according to the present invention.

FIG. 19 shows separate perspective, top and bottom, and elevation views of cylindrical catalyst with at least one internal generally pear-shaped axial hole and at least one external slot shaped hole according to the present invention.

FIG. 20 shows a graph of GSA v. RPSP of the cylindrical ring catalyst with four internal generally pear-shaped axial holes and four external slot shaped holes according to the present invention.

FIG. 21A shows separate perspective, top and bottom, and elevation views of cylindrical catalyst with at least one internal generally teardrop-shaped axial hole according to the present invention.

FIG. 21B shows a further top (or bottom) view of the catalyst of FIG. 21A.

FIG. 22 shows a graph of GSA v. RPSP of the cylindrical ring catalyst with six generally teardrop-shaped holes according to the present invention.

FIG. 23 shows a table that compares the predicted catalytic performance of a Raschig ring prior art catalyst with the predicted catalytic performance of a teardrop hole catalyst according to the present invention.

FIG. 24 shows a table that compares the predicted catalytic performance of a fluted ring prior art catalyst with the predicted catalytic performance of a slot-shaped hole catalyst according to the present invention.

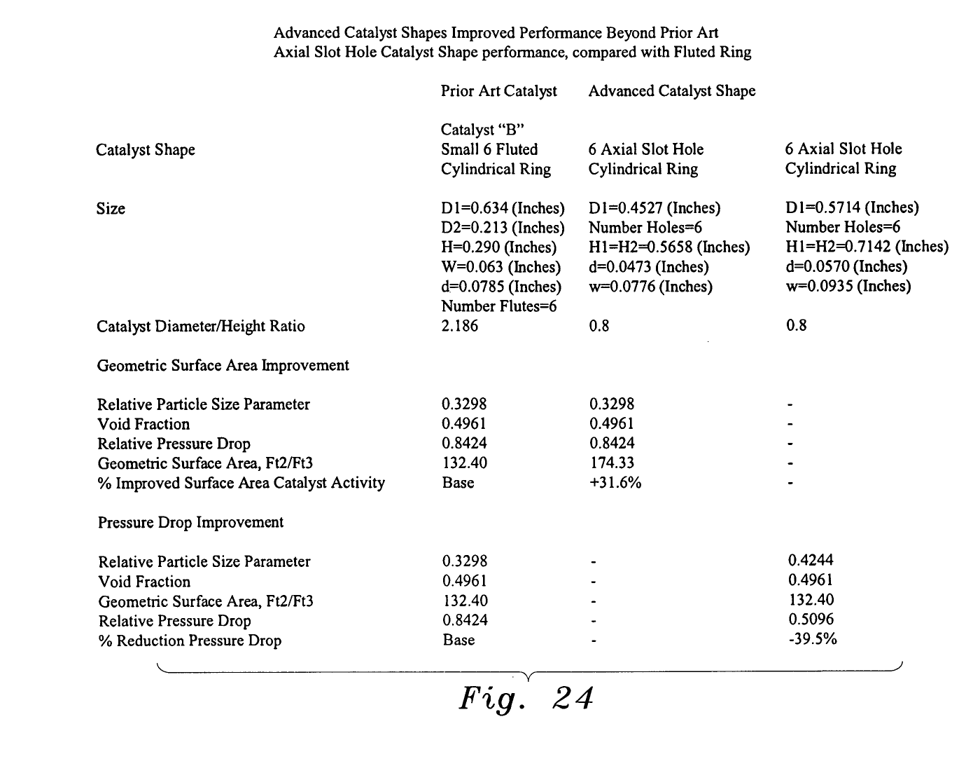

FIG. 25 shows a table that compares the predicted catalytic performance of a fluted ring prior art catalyst with the predicted catalytic performance of a four axial internal pear shaped hole and four external slot hole catalyst according to the present invention.

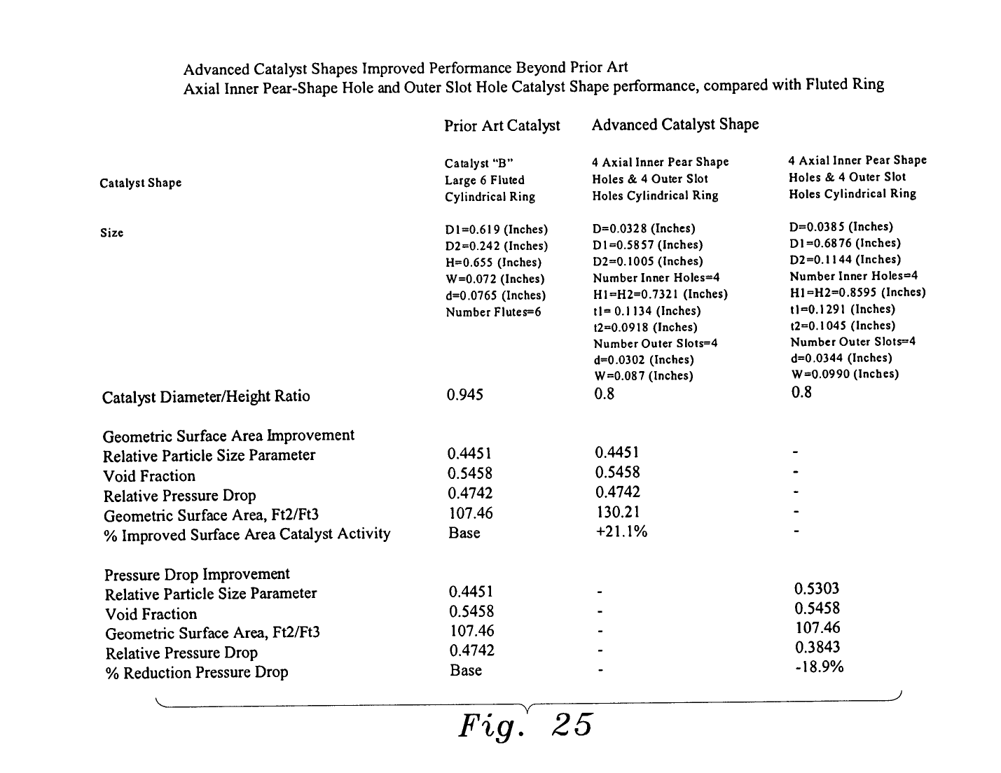

FIG. 26 shows a table that compares the predicted catalytic performance of a four-holed ring prior art catalyst with that of an axial internal pear holed catalyst according to the present invention.

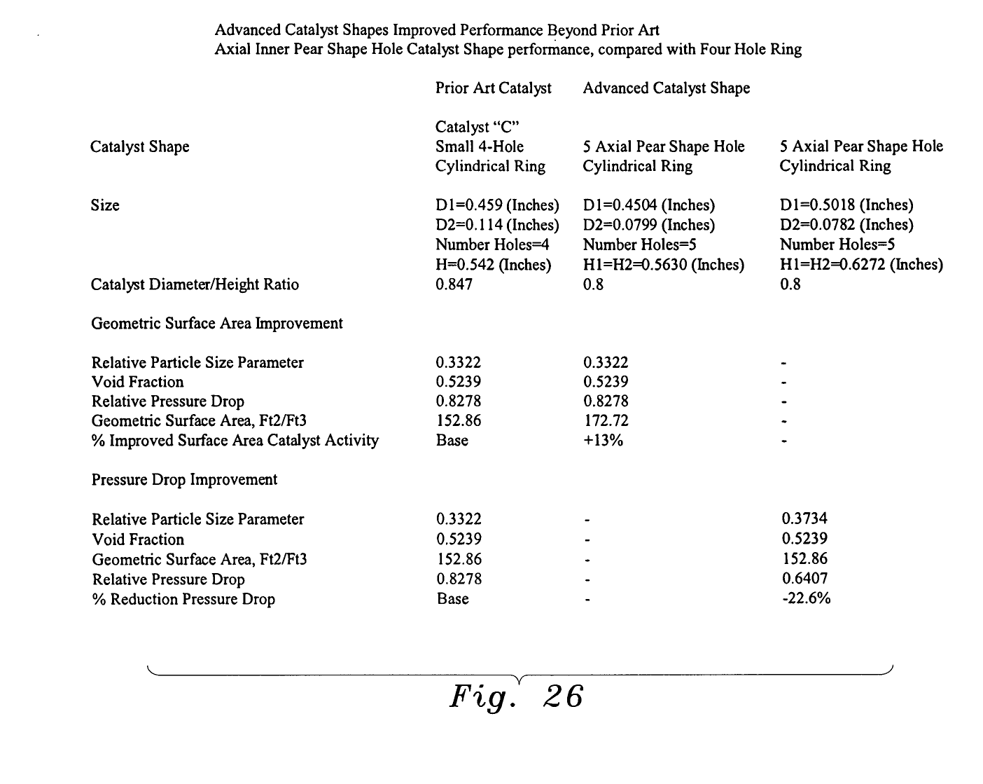

FIG. 27 shows a table that compares the predicted catalytic performance of a four holed ring prior art catalyst with the predicted catalytic performance of an axial internal rounded diamond holed catalyst according to the present invention.

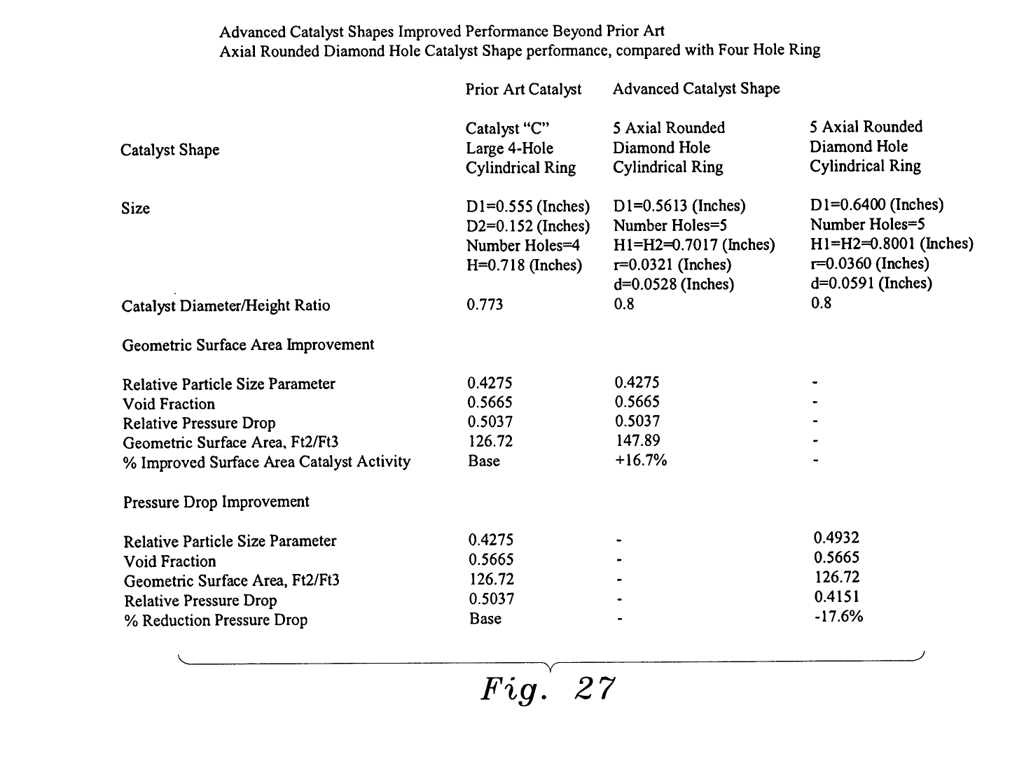

FIG. 28 shows a table that compares the catalytic performance of a seven-holed prior art ring catalyst with the predicted catalytic performance of an axial internal eliptical holed catalyst according to the present invention.

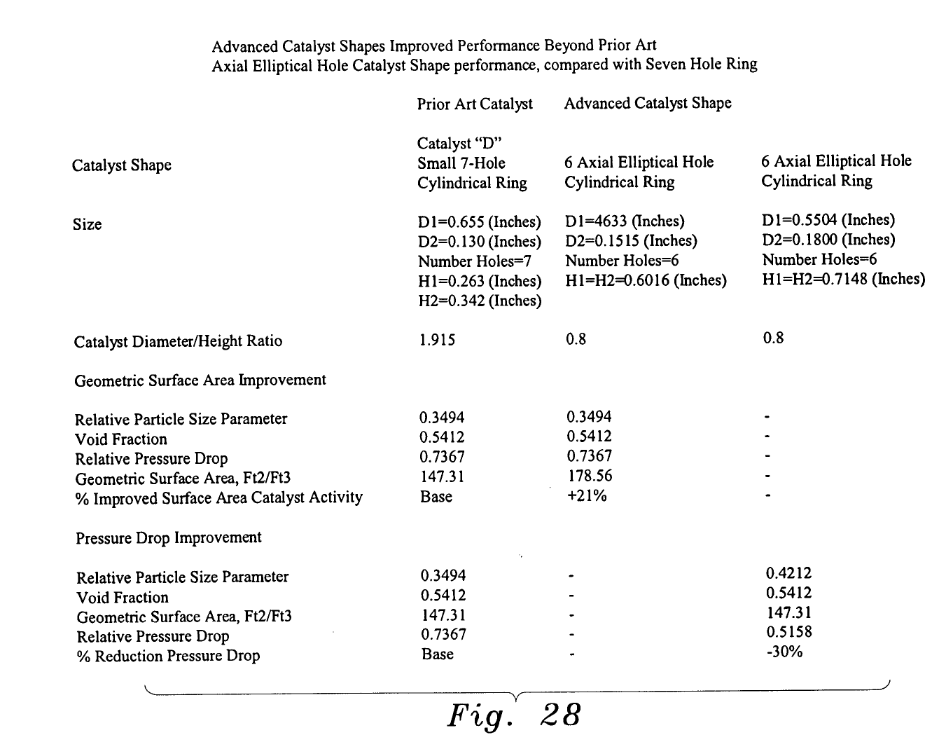

FIG. 29 shows a table that compares the catalytic performance of a seven-holed ring prior art catalyst with the predicted catalytic performance of an axial internal diamond holed catalyst according to the present invention.

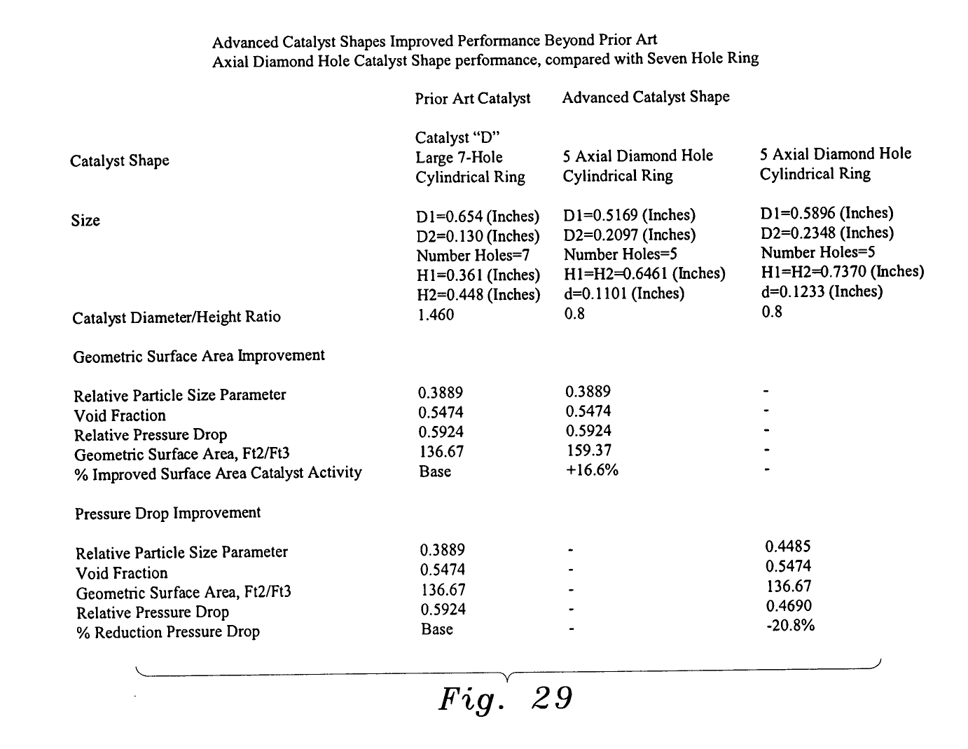

FIG. 30 shows a table that compares the catalytic performance of a seven spoke ring prior art catalyst with the predicted catalytic performance of an axial L-shaped hole catalyst according to the present invention.

### DETAILED DESCRIPTION OF THE PREFERRED EMBODIMENTS

The present invention is directed to advanced catalyst shapes that increase catalyst performance while reducing gas pressure drop.

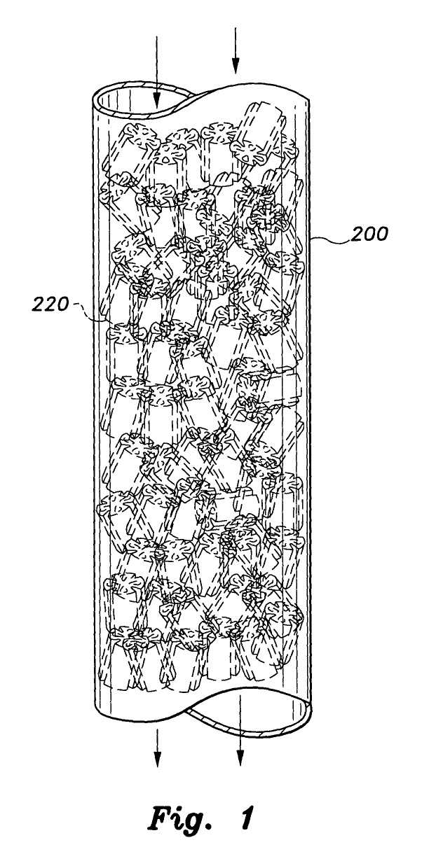

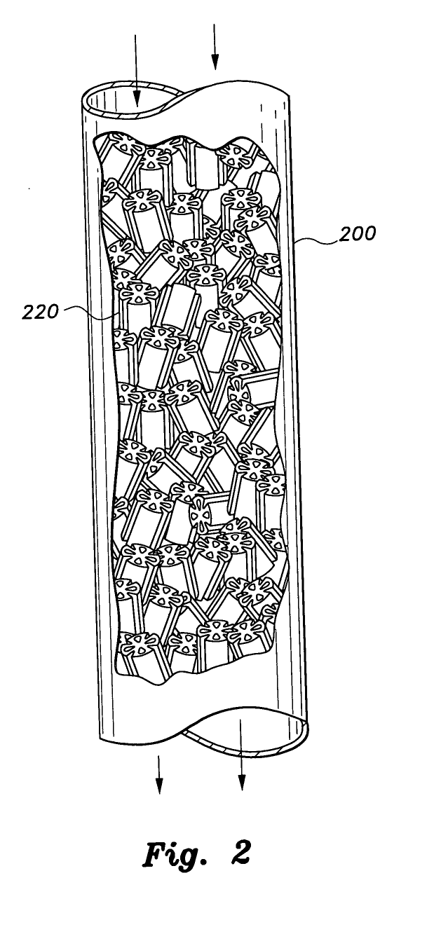

Referring to FIGS. 1 and 2, a segment of reaction tube 200 is shown filled with a plurality of improved catalyst particles 220 of the present invention. Reactants in gaseous form travel along the inside of the reaction tube 200 and undergo chemical conversion to desired gaseous reaction products, such as hydrogen, upon contact with the surfaces presented by the catalyst particles 220 according to the invention.

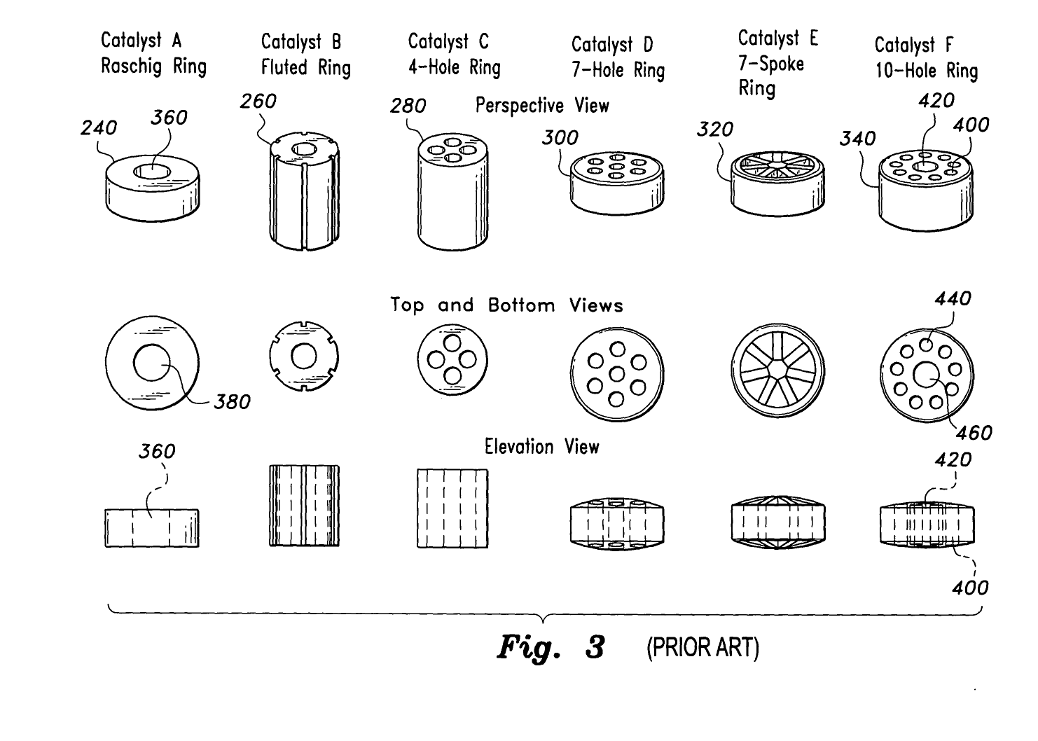

FIG. 3 shows separate perspective, top and bottom, and elevation views of a range of heterogeneous ring catalysts of the prior art, i.e., the Raschig 240, Fluted 260, 4-Hole 280, 7-Hole 300, 7-spoke 320, and 10-Hole 340 rings. The rings 240, 260, 280, 300, 320, and 340 are hereinafter also referred to as Catalyst A 240, Catalyst B 260, Catalyst C 280, Catalyst D 300, Catalyst E 320, and Catalyst F 340, respectively. Catalysts A to E are regarded as representative of the prior art.

Reference is made herein, for illustrative purposes only, to the prior art Raschig ring 240 and 10-Hole ring 340 (i.e., Catalyst A 240 and Catalyst F 340, respectively). Catalyst A 240 defines a hole 360 that passes completely through Catalyst A 240 to define an essentially identical aperture 380 in the top and bottom of Catalyst A 240. Catalyst F 340 defines an outer ring of holes 400 and a central hole 420. The outer ring of holes 400 surround the central hole 420. The holes 400 and 420 pass completely through the Catalyst F 340 to respectively define apertures 440 and 460, respectively, in the top and bottom of Catalyst F 340.

The theory of Relative Particle Size developed herein asserts that for a given reactor tube of specific size and operating temperature, with inlet pressure fixed along with unique fluid flow rate and reactant composition, there exists only one pressure drop for each unique catalyst “Relative Particle Size”. If the size of catalyst particles increase, regardless of the shape, the pressure-drop of the gas will decrease due to increased void fraction around fewer and larger catalyst particles in the tube. Thus the theory of Relative Particle Size indicates that as particles increase in size in a given tube flowing scenario, the gas pressure losses decrease. Catalyst particles can “effectively increase” in size through several means.

Increasing the overall external catalyst particle dimensions (diameter, height or both) results in a greater loaded catalyst void fraction resulting in lower gas pressure drop. Alternatively, the combined internal area of a hole or holes within catalyst particles may increase for otherwise fixed external catalyst dimensions causing the same effect, higher void fraction and lower gas pressure drop for gases passing through the catalyst. Thus, a “Relative Particle Size” exists for all catalysts of any proportions and shape, which combines all dimensional and shape characteristics into a singular Relative Particle Size Parameter.

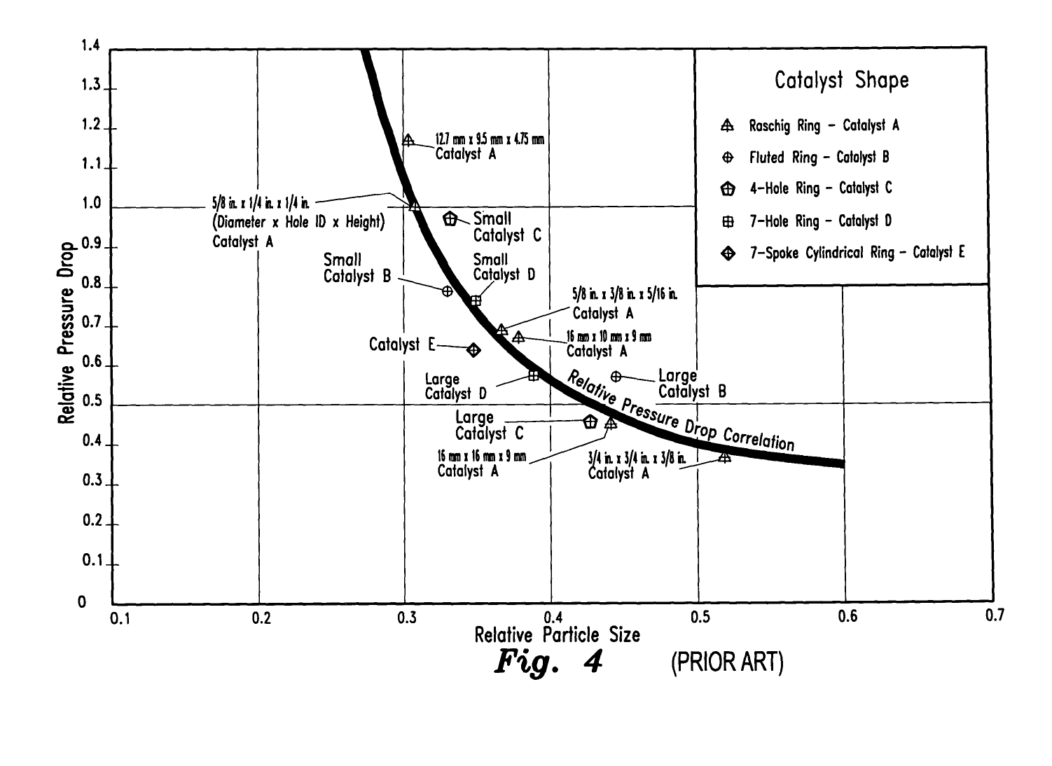

FIG. 4 shows the relationship between Relative Pressure Drop and Relative Particle Size calculated for the prior art Catalysts A to E. Relative Pressure Drop is defined as the ratio of the fluid pressure drop for one catalyst divided by the pressure drop of a different catalyst for a given set of fluid flow conditions with respect to the gaseous reactants flowing through the reaction tube and the prior art catalyst therein.

The present invention is directed to exploiting a Relative Particle Size Parameter (RPSP) for improving geometric surface area (GSA) and decreasing pressure-drop. The Relative Particle Size Parameter according to the invention takes account of the influence of catalyst void fraction as it varies with catalyst dimensions, number and size of interior holes in combination, along with shape/size aspects of a catalyst configuration to explain pressure drop. Relative Particle Size Parameter is defined as:

Fₕ=Catalyst Void Fraction, including holes

Ds=Shape Parameter of a catalyst particle

RPSP=Relative Particle Size Parameter=Fₕ^{0.597}*Dₛ^{1.0488422}

where,

Ds, is a Catalyst Shape Parameter, defined as:

Ds=(6*V_{act}/PI)^{(1/3)} (Inch Dimension)

where,

V_{act} is the Volume of Actual Catalyst Mass in cubic inches (excluding internal voidage)

PI=The Constant 3.1415926536

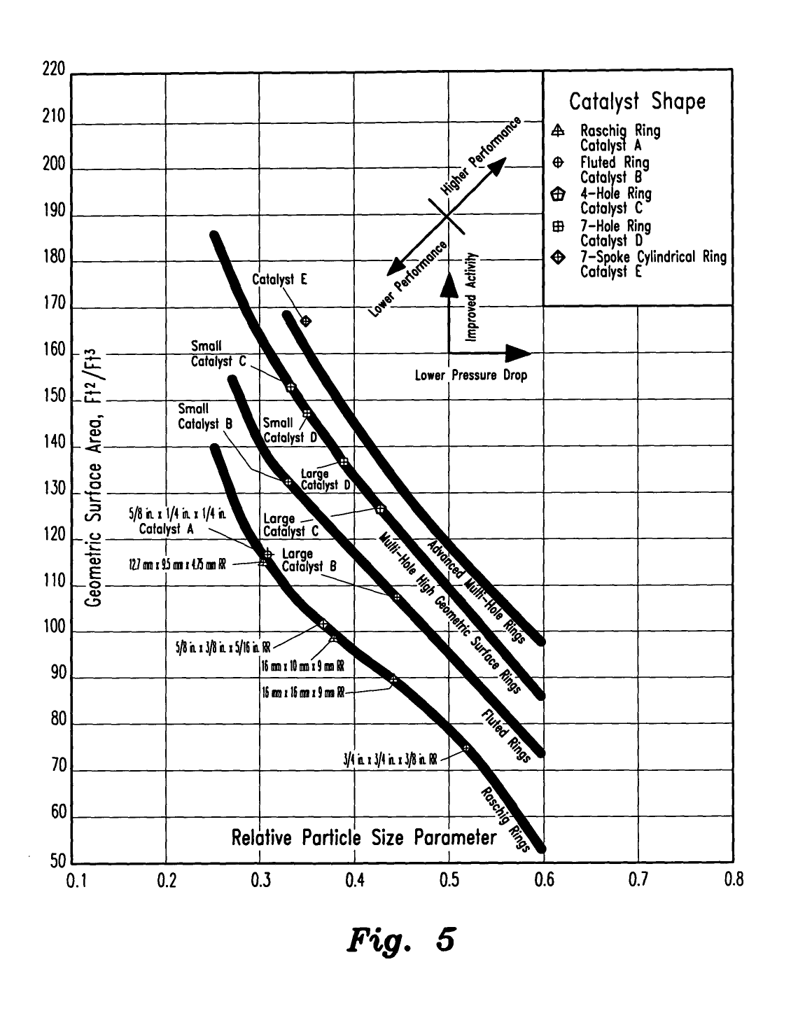

FIG. 5 is a graph of geometric surface area (GSA) verses the Relative Particle Size Parameter (RPSP) calculated for the prior art Catalysts A to E. Geometric surface area (GSA) is the available external exposed catalyst surface, per unit of catalyst volume, expressed as area/volume; for example Ft²/Ft³ (square feet per cubic foot) or m²/m³ (square meters per cubic meter). Each catalyst has a geometric surface area characteristic and a corresponding Relative Particle Size Parameter (RPSP).

Raschig Ring catalyst shapes have the lowest geometric surface area for varying Relative Particle Size Parameter. Similarly, catalysts with small flutes on the periphery of the ring have slightly higher GSA versus Relative Particle Size Parameter than Raschig Rings. Still higher GSA for variation of Relative Particle Size Parameter is achieved by catalyst shapes formed with variations of multiple axial circular holes fashioned within the ring. For example, Catalyst C and Catalyst D shapes have four or seven axial circular inner holes and align on a common GSA versus Relative Particle Size Parameter curve, with the difference between these shapes principally in the number and size of axial circular holes within the catalyst ring and their differing aspect ratio, (diameter to height ratio).

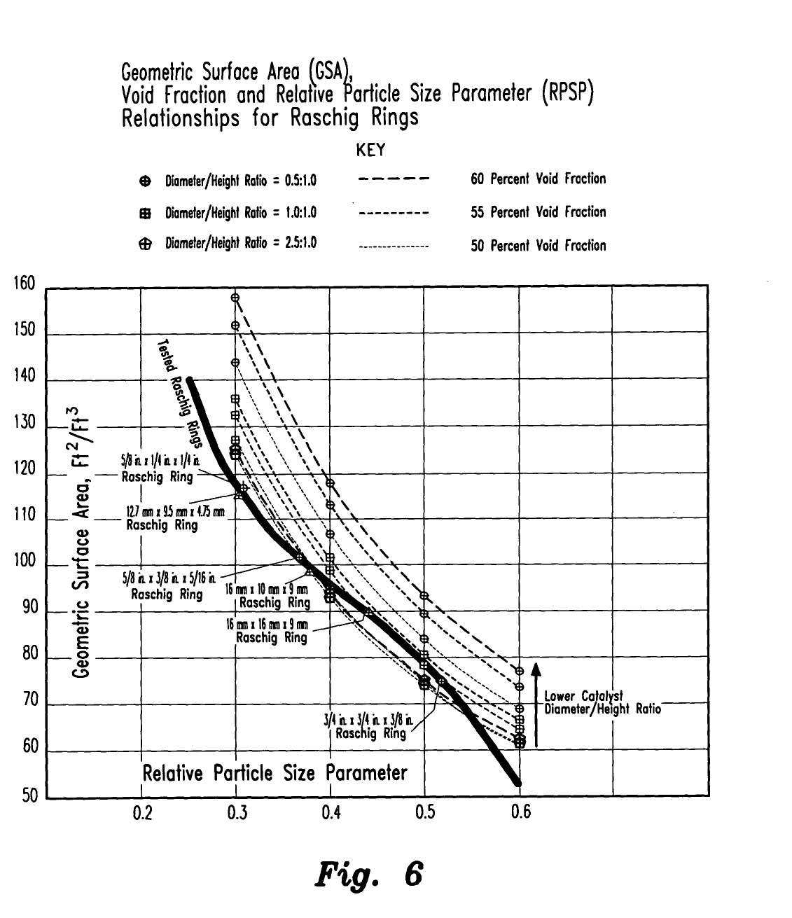

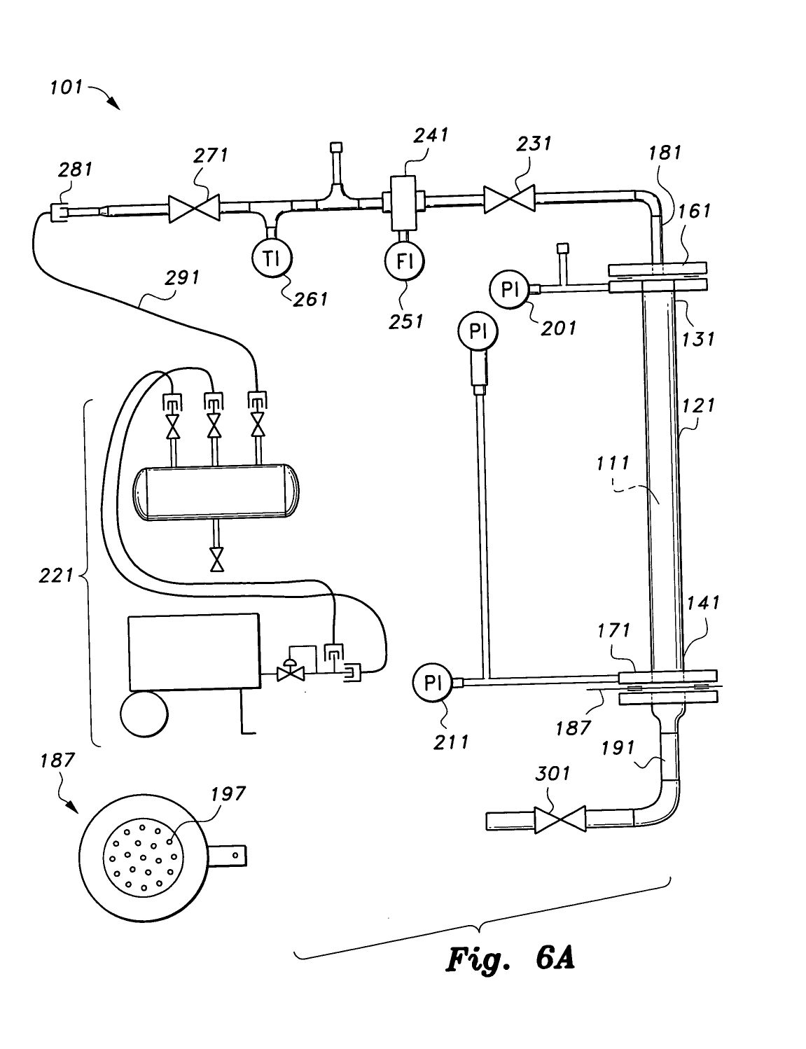

FIG. 6 is a graph of GSA verses RPSP for Raschig Ring catalyst shapes, and more particularly generalized GSA curves for different catalyst void fractions. The distinctive dashed curves shown on FIG. 6 illustrate 50, 55 and 60 percent void fractions for GSA versus Relative Particle Size and characterize the most important region for catalyst design and selections for catalysts in hydrocarbon reforming reactors. The separate symbols for individual dashed curves represent different diameter to height ratios for Raschig Ring catalyst shapes.

It is apparent from FIG. 6 that higher performance (greater GSA for given catalyst Relative Particle Size Parameter, “size”), can be accomplished by control of at least two variables void fraction or catalyst diameter/height ratio. Increasing void fraction for a catalyst shape can increase geometric surface area through increasing the size or number of holes within a catalyst ring of given external proportions. This is generally accomplished by increasing the number of internal holes while reducing internal hole size to keep the loaded catalyst void fraction in an optimally desirable range. The loaded catalyst void fraction is a critical parameter, because it directly determines the gaseous reactants velocity through and around catalyst particles, affecting turbulence and residence time within the catalyst. Alternatively, reducing catalyst diameter/height (length) ratio for a specific loaded catalyst void fraction and Relative Particle Size Parameter improves GSA and increases catalyst performance. In practice for circular axial multi-holed cylindrical catalyst shapes this is accomplished by reducing the number of holes through the catalyst, while simultaneously making the ring smaller diameter and longer, thereby maintaining a specific Relative Particle Size Parameter, likewise maintaining a specific Relative Pressure Drop.

There is yet another characteristic, related to catalyst shape that is not apparent from Raschig Ring catalyst shapes represented in FIG. 6. Refer back to FIG. 5. Catalyst E has a higher performance characteristic GSA versus Relative Particle Size Parameter than any of the other axial multi-holed catalyst shapes examined in this body of research. Refer to FIG. 3. Catalyst shape E also has a very high diameter/height ratio, typically greater than or about 2:1.

Small size Catalyst D (the axial 7 Hole Ring shape) has a similar diameter/height ratio as Catalyst E, and both of these shapes have nearly identical Relative Particle Size Parameter, (per FIG. 5), yet catalyst E has considerably greater GSA. Based upon GSA alone, Catalyst E is a higher performance, more efficient catalyst shape than Small size Catalyst D. In this example comparison, these two catalyst shapes have the same loaded catalyst void fraction, (0.555) making GSA a true indication of overall performance. As previously taught, it is possible for a particular catalyst shape to have higher GSA by permitting greater internal void fraction, (greater number of holes and hole area), resulting in higher overall loaded catalyst void fraction. Increasing the loaded catalyst void fraction is not necessarily desirable because it can lead to turbulence problems affecting reactants heat transfer, mixing and residence time in the catalyst.

The correlations of Relative Particle Size calculation of the invention unexpectedly established that greater performing catalysts are made from configurations of catalyst shapes that define holes of particularly shapes that are axially aligned, non-round shapes with uniform or non-uniform elongation of holes, with holes optimally positioned entirely within the outer ring diameter and favoring hole positioning in the region of the circular ring toward the outside diameter or periphery of the catalyst ring. This unexpected discovery explained why circular and regular-polygon shaped holes, (triangular, square, etc.), are not optimal shapes for optimizing catalyst performance.

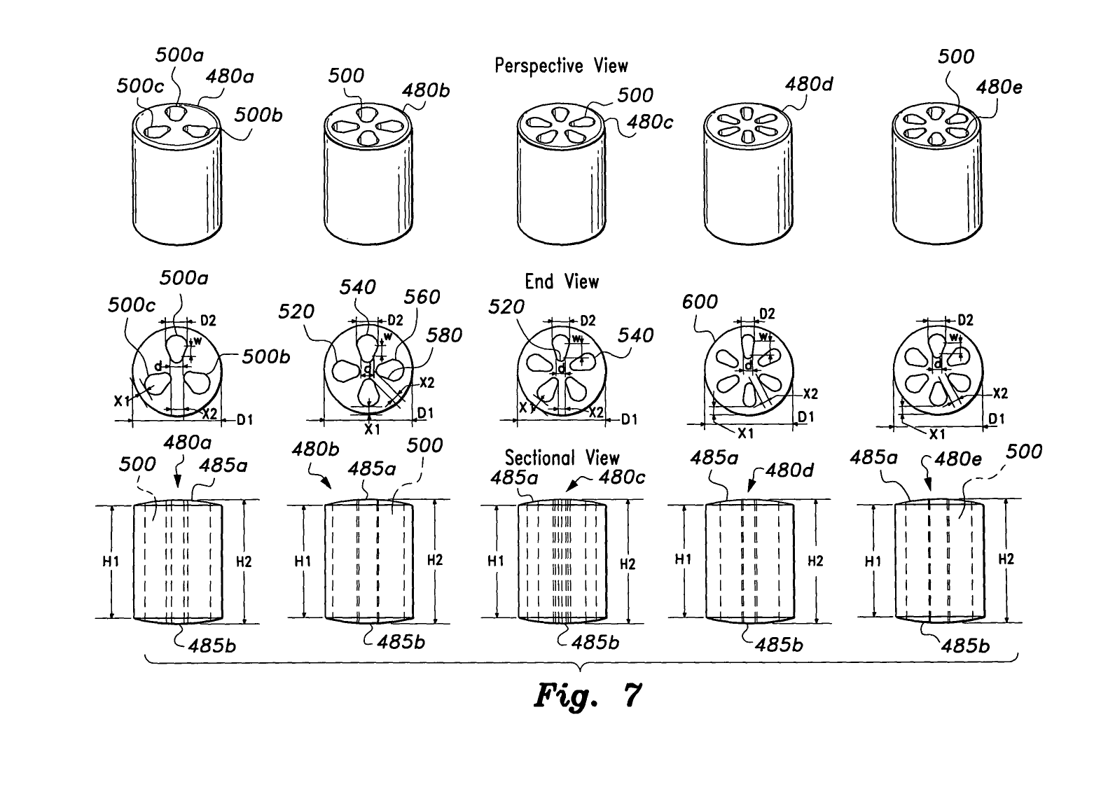

FIG. 6A shows a catalyst pressure drop measuring apparatus 101 to measure gas (air) pressure drop in at least one test catalyst 111 (e.g., cylindrical catalyst ring 480a in FIG. 7, see below). The testing apparatus 101 comprises a 3 inch diameter pressure tube 121 which contains the at least one catalyst 111; the pressure tube 121 is preferably a schedule-40 carbon steel tube. The pressure tube 121 has an inlet open end 131 and an exit open end 141; the opposite ends 131 and 141 respectively define inlet flange 161 and outlet flange 171, wherein flanges 161 and 171 are preferably 3″ (three inch) diameter 150 psi flanges. The inlet flange 161 is welded to a 1″ (one inch) inlet piping 181. The outlet flange 171 is welded to a 1½ inch schedule-40 outlet pipe 191 (the outlet pipe 191 comprises a gate valve 301); the outlet flange 171 comprises a 3/16 inches thick catalyst support plate 187 that is sandwiched inside the outlet flange 171 as shown in FIG. 6A. The catalyst support plate 187 supports the at least one catalyst 111. The catalyst support plate 187 comprises a plurality of perforations 197 that permit airflow through the pressure tube 121 (and by default the at least one catalyst 111). The test apparatus 101 is designed to use a minimum quantity of test catalyst 111 and to reach a reproducible pressure at the inlet flange 161.

The flanges 161 and 171 comprise a series of holes to allow pressure measurements directly at the inlet 131 and outlet 141 ends of the pressure tube 121 using pressure measuring apparatus 201 and 211 to determine the pressure drop between the inlet 161 and outlet flanges 171 for different test catalysts 111 to provide comparative data for later analysis. The pressure measuring apparatus 201 and 211 comprise pressure gauges labeled “PI”.

The inlet piping 181 is connected to an air compressor system 221. The inlet piping 181 includes an inlet globe valve 231, an armored rotor-meter 241 connected to an airflow meter 251 labeled “FI”, an air temperature indicator 261 (labeled “TI” in FIG. 6A), a gate valve 271, and a compressed air connector 281. The connector 281 is attached to a pressure airline 291 and thence to the air compressor system 221. The airflow meter 251 and air temperature indicator 261 provide airflow and temperature data to permit a person of ordinary skill in the art to normalize the pressure data collected by the pressure measuring devices 201 and 211.

The testing apparatus 101 is run for about a minute to reach equilibrium before pressure readings are taken at the inlet 161 and outlet flanges 171. Therefore, both inlet and exit pressure can be obtained in a very short time for a variety of induced pressures at the inlet flange 161. A catalyst that exhibits a comparatively lower pressure drop is representative of an improved catalyst.

### EXAMPLE 1

FIG. 7 shows separate perspective, top and bottom, and elevation views of cylindrical catalyst rings 480 with at least one internal pear-shaped hole 500 according to the present invention. The rings 480a, 480b, 480c, 480d, and 480e define at least one internal generally pear-shaped hole 500 that runs right through the cylindrical ring 480 emerging at both ends of the ring 480. For example, the cylindrical ring 480a defines three internal pear-shaped holes 500a, 500b, and 500c; each of the holes 500a, 500b, and 500c run through the cylindrical catalyst 480a. It is preferred that the axial pear-hole cylindrical ring 480 defines at least three pear shaped holes 500. Each at least one pear shaped hole 500 defines a first 520 and second 540 opposite ends of overall semi-circular shape, wherein the first opposite end has a diameter “d” and the second opposite end has a diameter “D2”, further wherein D2 is greater than d.

The first 520 and second 540 opposite ends define opposite facing tapering sides 560 and 580. The catalyst 480 may optionally defined curved or domed opposite ends 485a and 485b. The ends 485a and 485b may be spherical, ellipsoidal or another curved shape, or may be flat and circular. The dimensions d and D2 may be increased or decreased depending on the number of holes 500 in the cylindrical catalyst rings 480 (e.g., 480a). The advanced circular cylindrical catalyst shape 480 has a preferred diameter to height ratio in the range of 0.5:1 to 2.0:1, and more preferably in the range of about 0.5:1 and 1.0:1.0.

Still referring to FIG. 7, with respect to catalyst strength issues, dimensions “X1” and “X2” are shown. The dimensions X1 and X2 represent the ligaments of catalyst material between the circumference 600 and holes 500 of the catalyst particle 480. It will be evident to a person of ordinary skill in the art that the dimensions X1 and X2 are dependent on the other dimensions and the number of generally pear shaped holes 500. For example, the dimensions of the five holes 500a, 500b, 500c, 500d, and 500e can be fixed as: D2=20% of D1, d=10% of D1, w=18.9% of D1, x1=8.4% of D1, and x2=8.4% of D1.

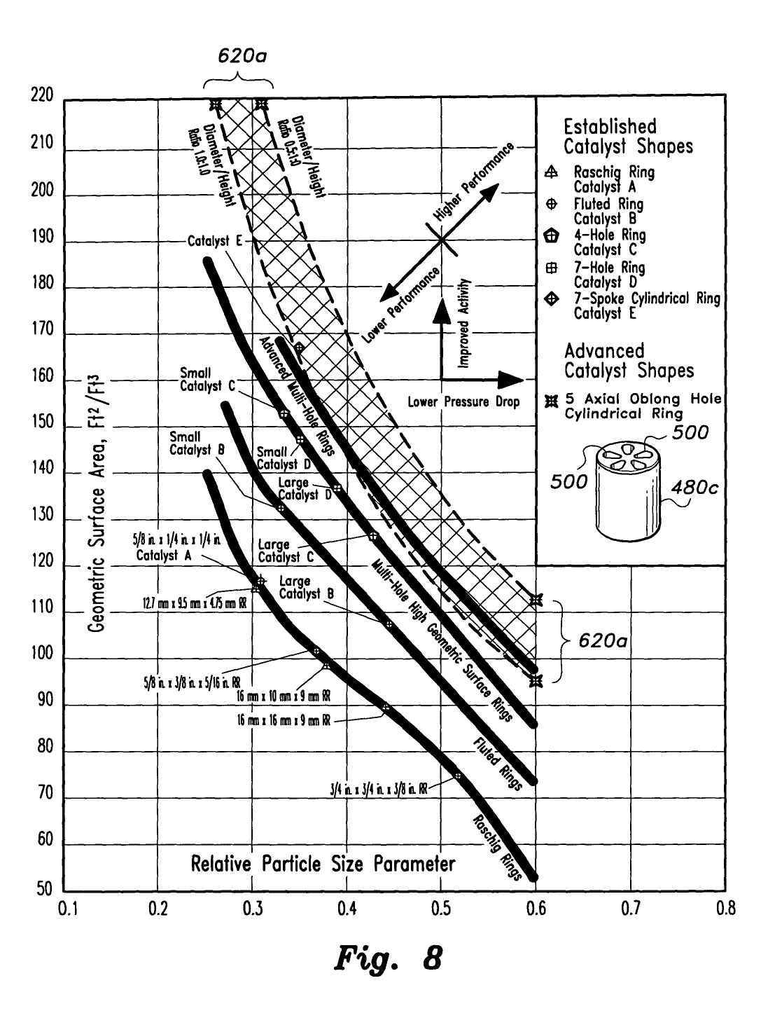

FIG. 8 shows a graph of GSA v. RPSP of the cylindrical ring catalyst 480c with five internal generally pear shaped holes 500. The hatched area 620a indicates potential selections of the cylindrical ring catalyst 480c with a diameter to height ratio in the range between about 0.5:1 to 1.0:1.0. The high performance catalyst particle 480c has a higher Relative Particle Size Parameter (RPSP) and a Geometric Surface Area (GSA) for a particular RPSP than Catalyst A through to Catalyst E.

### EXAMPLE 2

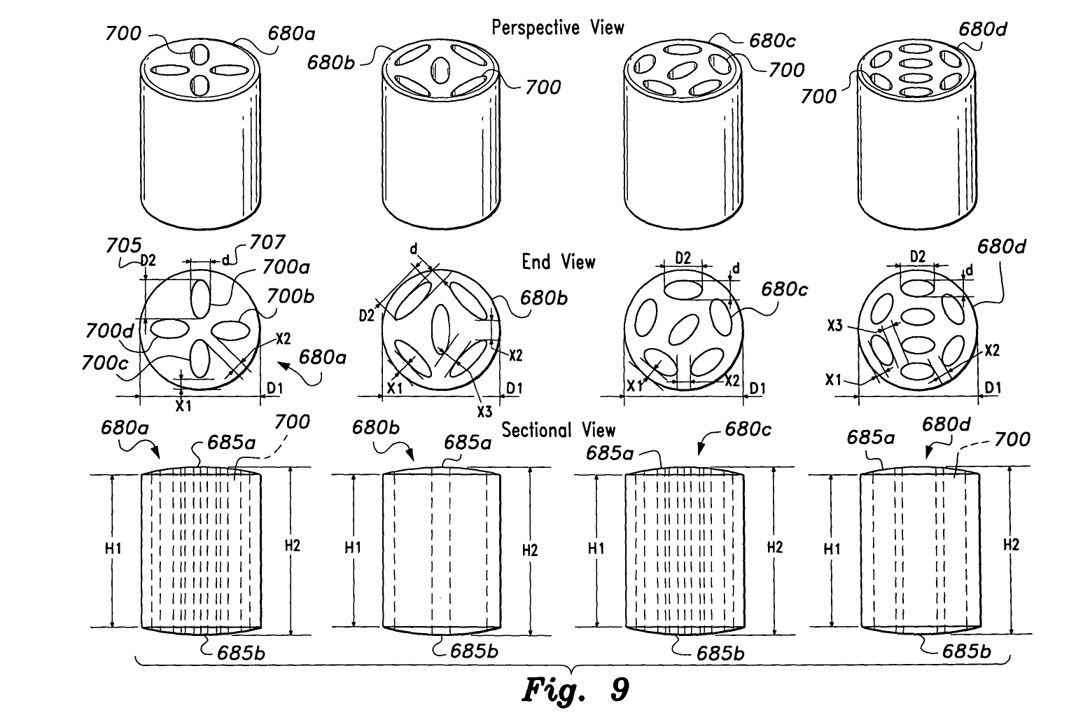

FIG. 9 shows separate perspective, top and bottom, and elevation views of cylindrical catalyst rings 680, and more specifically cylindrical catalyst rings 680a, 680b, 680c, and 680d according to the invention. The cylindrical catalyst ring 680 may optionally defined curved or domed opposite ends 685a and 685b. The ends 685a and 685b may be spherical, ellipsoidal or another curved shape, or may be flat and circular. The cylindrical catalyst rings 680a, 680b, 680c, and 680d define at least one internal generally elliptical shaped hole 700 that runs right through the cylindrical ring 680 to emerge at both ends of the ring 680. For example, the cylindrical ring 680a defines four internal elliptical shaped holes 700a, 700b, 700c and 700d. It is preferred that the cylindrical ring 680 defines at least three internal elliptical shaped holes 700. Each at least one internal elliptical shaped hole 700 has a length 705 and a width 707. The dimensions 705 and 707 may be increased or decreased depending on the number of internal holes 700 in the cylindrical catalyst rings 680 (e.g., 680a). The advanced circular cylindrical catalyst shape 680 has a preferred diameter to height ratio in the range of 0.5:1 to 2.0:1, and more preferably in the range of about 0.5:1 and 1.0:1.0.

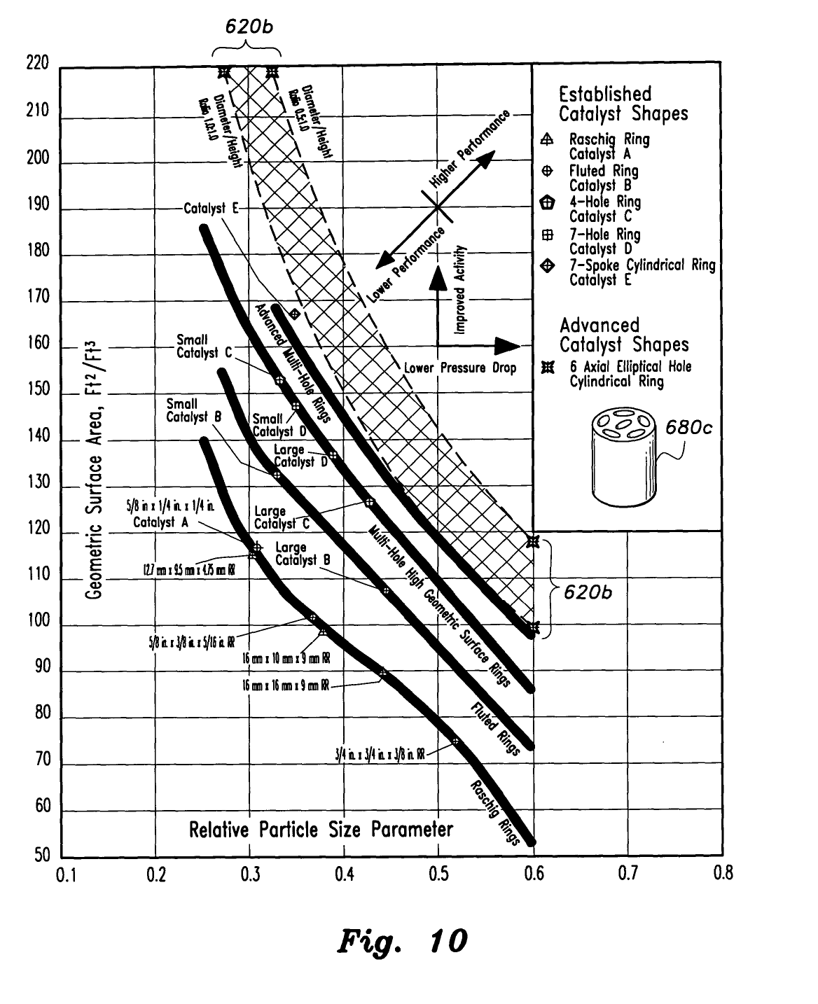

FIG. 10 shows a graph of GSA v. RPSP of the cylindrical ring catalyst 680c with six internal generally elliptical shaped holes 700. The hatched area 620b indicates potential selections of the cylindrical ring catalyst 680c with a diameter to height ratio in the range between about 0.5:1 to 1.0:1.0. The high performance catalyst particle 680c has a higher Relative Particle Size Parameter (RPSP) and a Geometric Surface Area (GSA) for a particular RPSP than a prior art catalyst particle.

### EXAMPLE 3

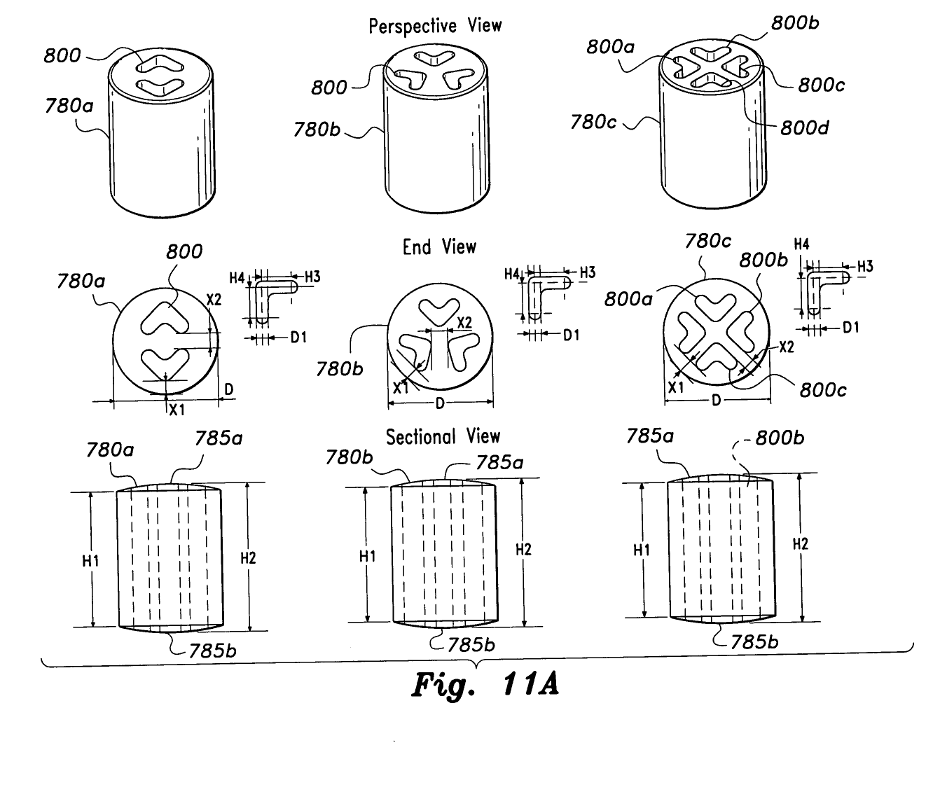

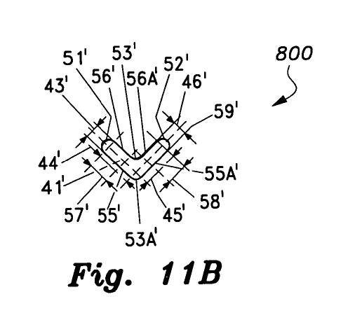

FIG. 11A shows separate perspective, top and bottom, and elevation views of cylindrical catalyst rings 780, and more specifically cylindrical catalyst rings 780a, 780b, and 780c according to the present invention. The rings 780a, 780b, and 780c define at least one generally L-shaped hole 800. For example, the axial L-holed cylindrical ring 780c defines four L-shaped holes 800a, 800b, 800c and 800d. It is preferred that the axial L-hole cylindrical ring 780 defines at least two L-shaped holes 800. Each at least one L-shaped hole 800 has a length 705 and a width 707. The catalyst 780 may optionally defined curved or domed opposite ends 785a and 785b. The ends 785a and 785b may be spherical, ellipsoidal or another curved shape, or may be flat and circular.

With respect to FIG. 11B the L-shaped holes are formed of circular or other curve shape hole ends 51′ and 52′, having widths 43′ and 46′. Widths 43′ and 46′ are generally, but not necessarily of equal length. FIG. 11B shows straight sides of L-shaped hole 800 as 55′ and 55A′ having lengths indicated as 44′ and 45′ and straight sides of L-shaped hole 800 as 56′ and 56A′ having lengths indicated as 57′ and 58′, further connected to inner and outer curves 53′ and 53A′, combined with hole ends 51′ and 52′ to form the characteristic L-shaped hole of this invention. Lengths 44′ and 45′ generally may be, but are not necessarily equal. Lengths 57′ and 58′ generally may be, but are not necessarily equal. Inner and outer curves 53′ and 53A′ may be of circular shape or another curve shape. Dashed lines 59′ in FIG. 11B indicate the positions where curved ends 51′, 52′, inner and outer curves 53′ and 53A′, straight sides 55′ and 55A′ and 56′ and 56A′ connect to form L-shaped hole 800.

Still referring to FIG. 11B, the L-shaped hole characteristic dimensions 43′, 44′, 45′, 46′, 57′ and 58′ may be so altered as desired along with the number of holes 800 to obtain an optimal hole pattern within the interior of the catalyst shape 780 to achieve desired catalyst performance. The orientation of the L-shaped holes 800 arrangement may vary, being parallel or perpendicular to the radius from the central axis of the ring to the outer diameter or in other arrangements, depending on the number of L-shaped holes 800 selected, and catalyst strength or manufacturing issues. The advanced circular cylindrical catalyst shape 780 has a preferred diameter to height ratio in the range of 0.5:1 to 2.0:1, and more preferably in the range of about 0.5:1 and 1.0:1.0.

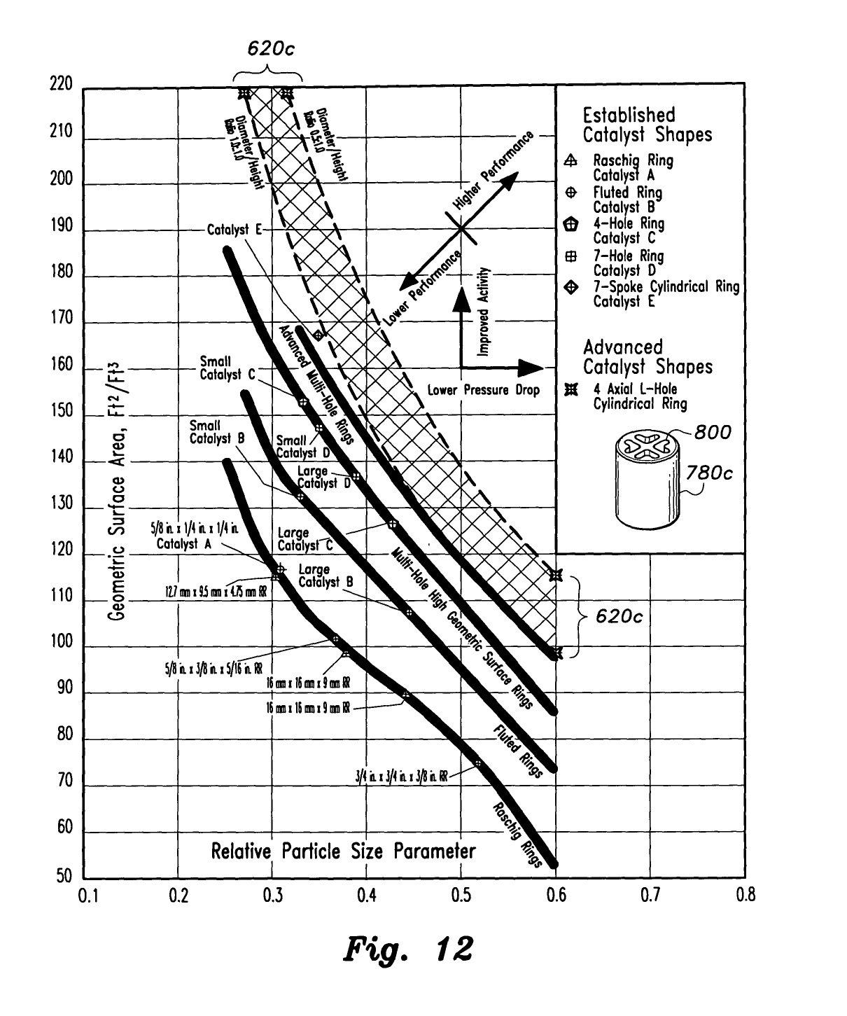

FIG. 12 shows a graph of GSA v. RPSP of the cylindrical ring catalyst 780c with four internal generally L-shaped holes 800 (i.e., 800a, 800b, 800c and 800d). The hatched area 620c indicates potential selections of the cylindrical ring catalyst 780c with a diameter to height ratio in the range between about 0.5:1 to 1.0:1.0. The high performance catalyst particle 780c has a higher Relative Particle Size Parameter (RPSP) and a Geometric Surface Area (GSA) for a particular RPSP than a prior art catalyst particle.

### EXAMPLE 4

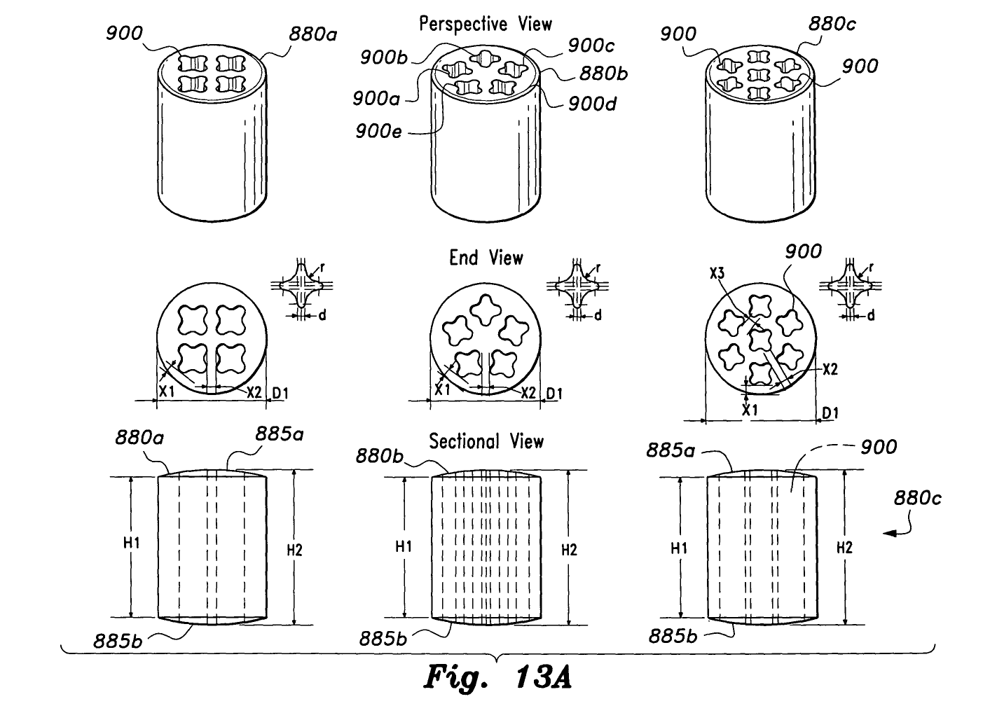

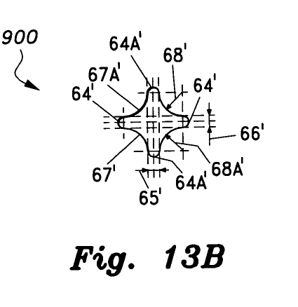

FIG. 13A shows separate perspective, top and bottom, and elevation views of cylindrical catalyst rings 880, and more particularly cylindrical catalyst rings 880a, 880b, and 880c according to the present invention. The catalyst 880 may optionally defined curved or domed opposite ends 885a and 885b. The ends 885a and 885b may be spherical, ellipsoidal or another curved shape, or may be flat and circular.

Still referring to FIG. 13A, the rings 880a, 880b, and 880c define at least one internal generally rounded-diamond-shaped hole 900. For example, the axial rounded-diamond-holed cylindrical ring 880b defines five generally rounded-diamond-shaped holes 900a, 900b, 900c, 900d and 900e. It is preferred that the axial rounded-diamond-holed cylindrical ring 880 defines at least three rounded-diamond-shaped holes 900.

FIG. 13B shows a top view of an axial rounded-diamond-hole 900. The axial rounded-diamond-hole 900 defines end curves 64′ and 64A′, having widths 65′ and 66′, and curved sides 67′, 67A′, 68′ and 68A′. Widths 65′ and 66′ are generally, but not necessarily of equal length. Curved sides 67′ and 67A′ and end curves 64′ and 64A′ may be circular or other curved shapes. Lengths 65′ and 66′ generally may be, but are not necessarily equal.

Still referring to FIG. 13B, the rounded diamond-shaped hole characteristic dimensions 65′, 66′, and the length of curved sides 67′, 67A′, 68′ and 68A′ may be so altered as desired along with the number of holes 900 to obtain an optimal hole pattern within the interior of the catalyst shape 880 to achieve desired catalyst performance. The orientation of the Rounded Diamond-shaped holes 900 arrangement may vary, being parallel or perpendicular to the radius from the central axis of the ring to the outer diameter or in other arrangements, depending on the number of Rounded Diamond-shaped holes 900 selected, and catalyst strength or manufacturing issues. The advanced circular cylindrical catalyst shape 880 has a preferred diameter to height ratio in the range of 0.5:1 to 2.0:1, and more preferably in the range of about 0.5:1 and 1.0:1.0.

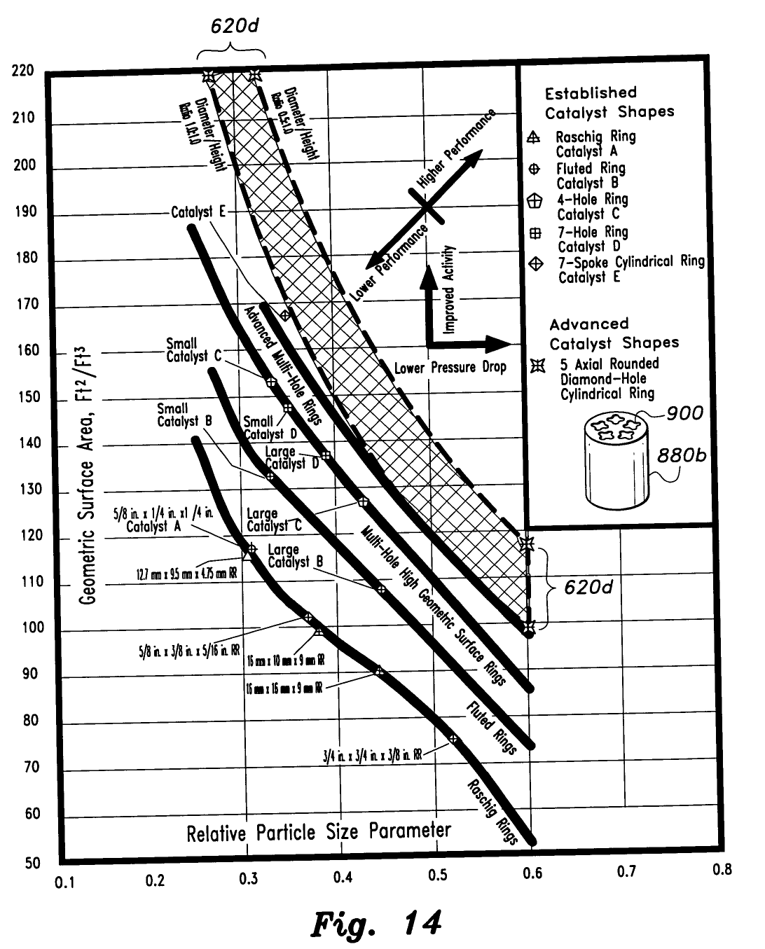

FIG. 14 shows a graph of GSA v. RPSP of the cylindrical ring catalyst 880b having five internal generally rounded-diamond-shaped holes 900a, 900b, 900c, 900d and 900e. The hatched area 620d indicates potential selections of the cylindrical ring catalyst 880b with a diameter to height ratio in the range between about 0.5:1 to 1.0:1.0. The high performance catalyst particle 880b has a higher Relative Particle Size Parameter (RPSP) and a Geometric Surface Area (GSA) for a particular RPSP than a prior art catalyst particle.

### EXAMPLE 5

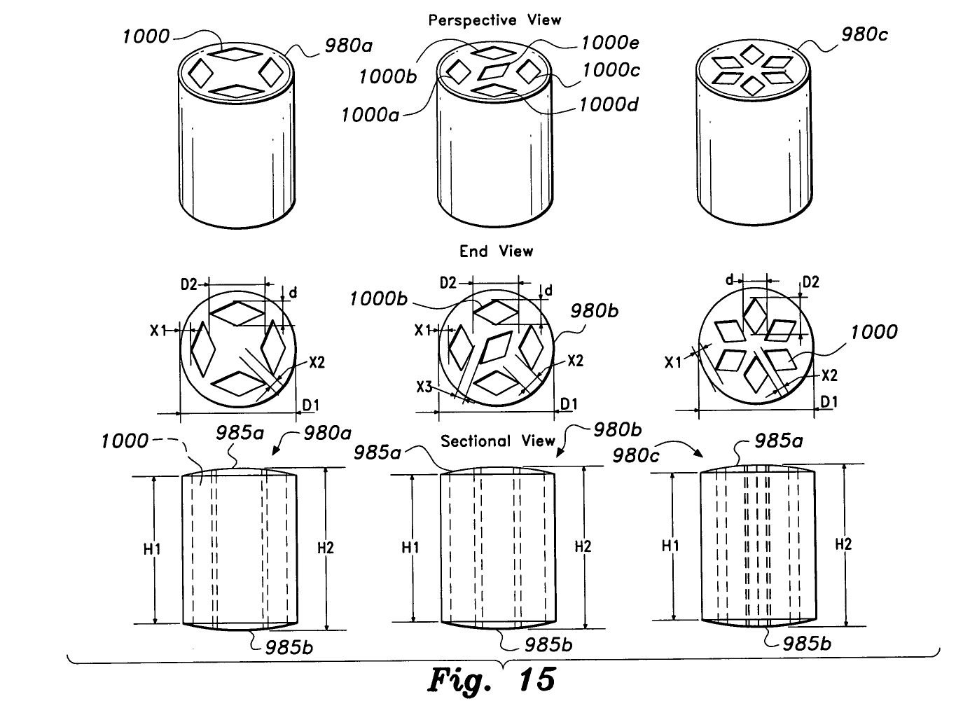

FIG. 15 shows separate perspective, top and bottom, and elevation views of cylindrical catalyst rings 980, and more specifically cylindrical catalyst rings 980a, 980b, and 980c according to the present invention. The cylindrical catalyst 980 may optionally defined curved or domed opposite ends 985a and 985b. The ends 985a and 985b may be spherical, ellipsoidal or another curved shape, or may be flat and circular. The cylindrical catalyst rings 980a, 980b, and 980c define at least one generally diamond-shaped hole 1000. For example, the axial diamond-holed cylindrical ring 980b defines five generally rounded-diamond-shaped holes 1000a, 1000b, 1000c, 1000d and 1000e. It is preferred that the axial diamond-holed cylindrical ring 980 defines at least three diamond-shaped holes 1000.

Still referring to FIG. 15, the Diamond-shaped hole characteristic dimensions “d” and “D2” may be so altered as desired along with the number of holes 1000 to obtain an optimal hole pattern within the interior of the catalyst shape 980 to achieve desired catalyst performance. The orientation of the Diamond-shaped holes 1000 arrangement may vary, being parallel or perpendicular to the radius from the central axis of the ring to the outer diameter or in other arrangements, depending on the number of Diamond-shaped holes 1000 selected, and catalyst strength or manufacturing issues. The advanced circular cylindrical catalyst shape 980 has a preferred diameter to height ratio in the range of 0.5:1 to 2.0:1, and more preferably in the range of about 0.5:1 and 1.0:1.0.

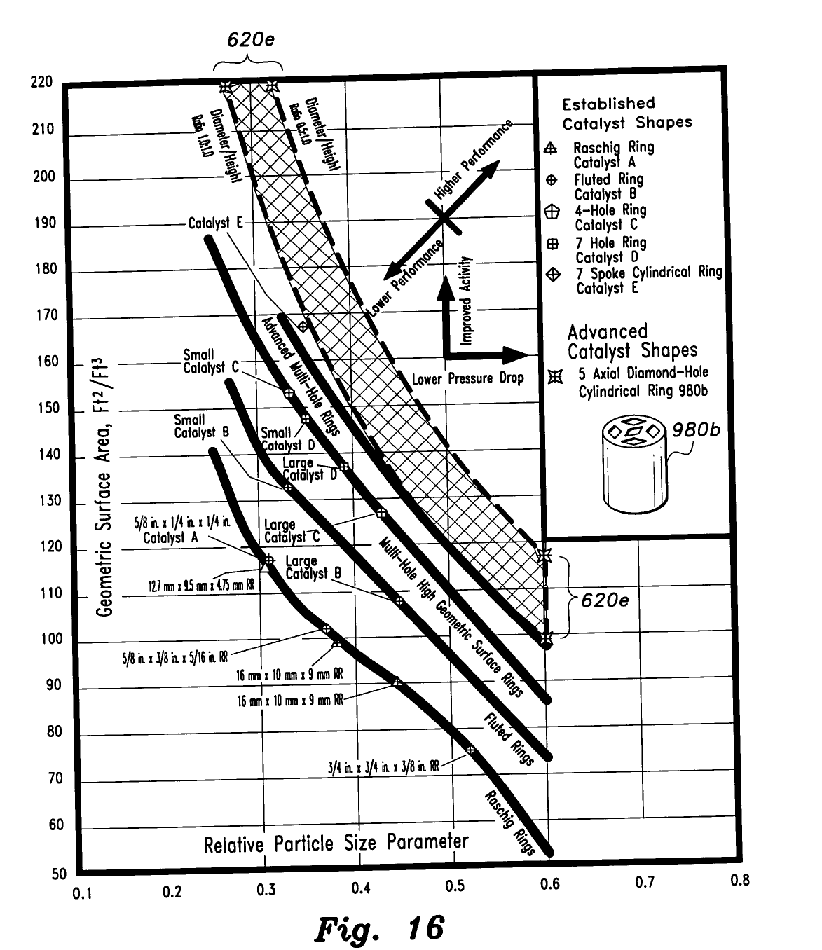

FIG. 16 shows a graph of GSA v. RPSP of the cylindrical ring catalyst 980b with five internal generally rounded-diamond-shaped holes 1000a, 1000b, 1000c, 1000d and 1000e. The hatched area 620e indicates potential selections of the cylindrical ring catalyst 980b with a diameter to height ratio in the range between about 0.5:1 to 1.0:1.0. The high performance catalyst particle 980b has a higher Relative Particle Size Parameter (RPSP) and a Geometric Surface Area (GSA) for a particular RPSP than a prior art catalyst particle.

### EXAMPLE 6

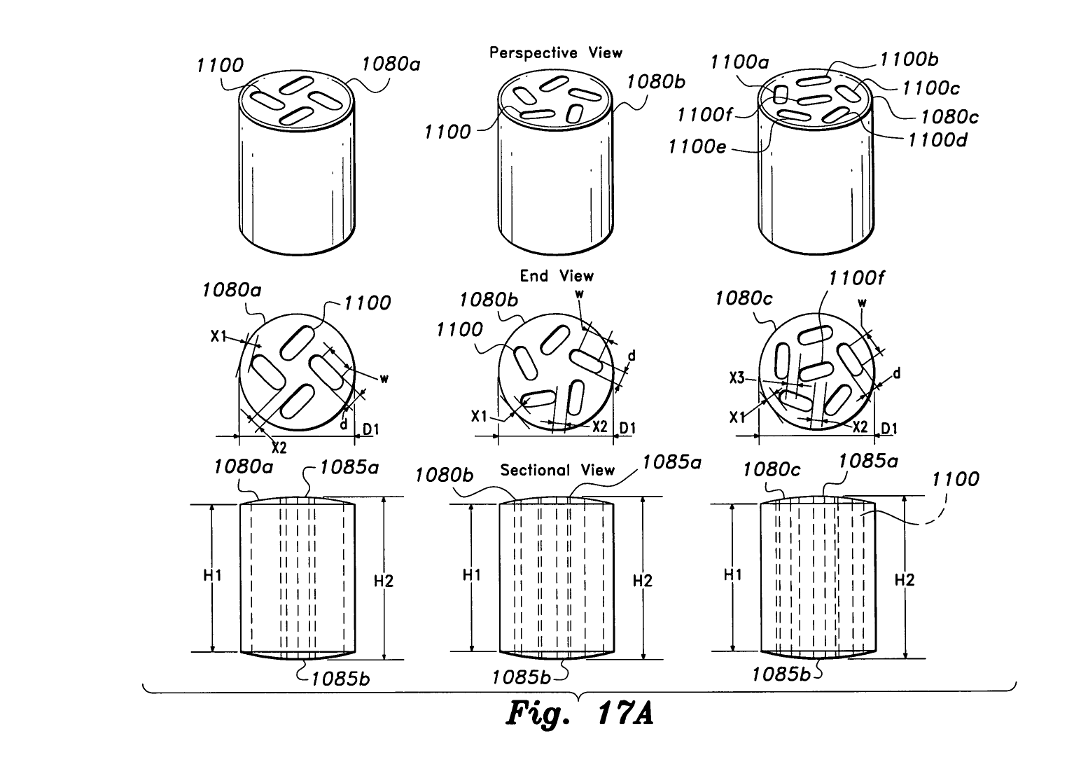

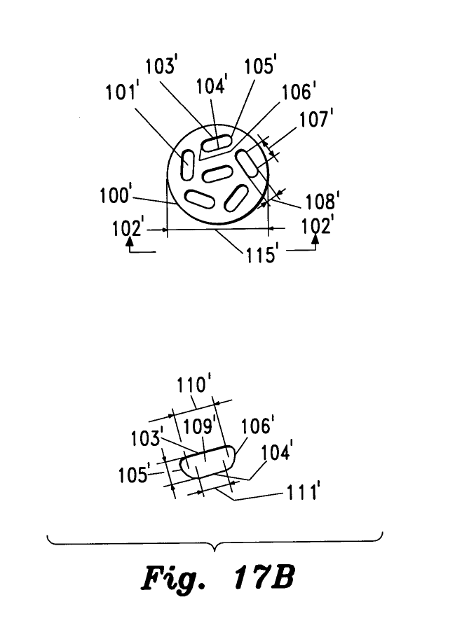

FIG. 17A shows separate perspective, top and bottom, and elevation views of cylindrical catalyst rings 1080, and more specifically cylindrical catalyst rings 1080a, 1080b, and 1080c according to the present invention. The cylindrical catalyst ring 1080 may optionally defined curved or domed opposite ends 1085a and 1085b. The ends 1085a and 1085b may be spherical, ellipsoidal or another curved shape, or may be flat and circular. The cylindrical rings 1080a, 1080b, and 1080c define at least one generally slot-shaped hole 1100. For example, the axial slot-holed cylindrical ring 1080c defines six generally slot-shaped holes 1100a, 1100b, 1100c, 1100d, 1100e and 1100f. It is preferred that the axial slot-holed cylindrical ring 1080 defines at least three generally slot-shaped holes 1100.

The slot shaped holes 1100 define straight sides 103′ and 104′ and curved ends 105′ and 106′, which may be semi-circular or another curved shape. Straight sides 103′ and 104′ can be substantially equal length. Characteristic widths of slot shaped holes 1100 are shown as 107′ and 108′. However, the overall shape of the slot shaped holes 1100 can vary without detracting from the spirit of the present invention. For example, FIG. 17B shows an asymmetric slot shaped hole 1100′ with sides 103′ and 104′ that are unequal in length, and curved ends 105′ and 106′ that are non-circular in overall shape.

Still referring to FIG. 17B, the Slot-shaped hole characteristic dimensions of straight sides 103 and 104 and curved ends 105 and 106 may be so altered as desired along with the number of holes 1100 to obtain an optimal hole pattern within the interior of the catalyst shape 1080 to achieve desired catalyst performance. The orientation of the slot-shaped holes 1100 arrangement may vary, being parallel or perpendicular to the radius from the central axis of the ring to the outer diameter or in other arrangements, depending on the number of slot-shaped holes 1100 selected, and catalyst strength or manufacturing issues. The advanced circular cylindrical catalyst shape 1080 has a preferred diameter to height ratio in the range of 0.5:1 to 2.0:1, and more preferably in the range of about 0.5:1 and 1.0:1.0.

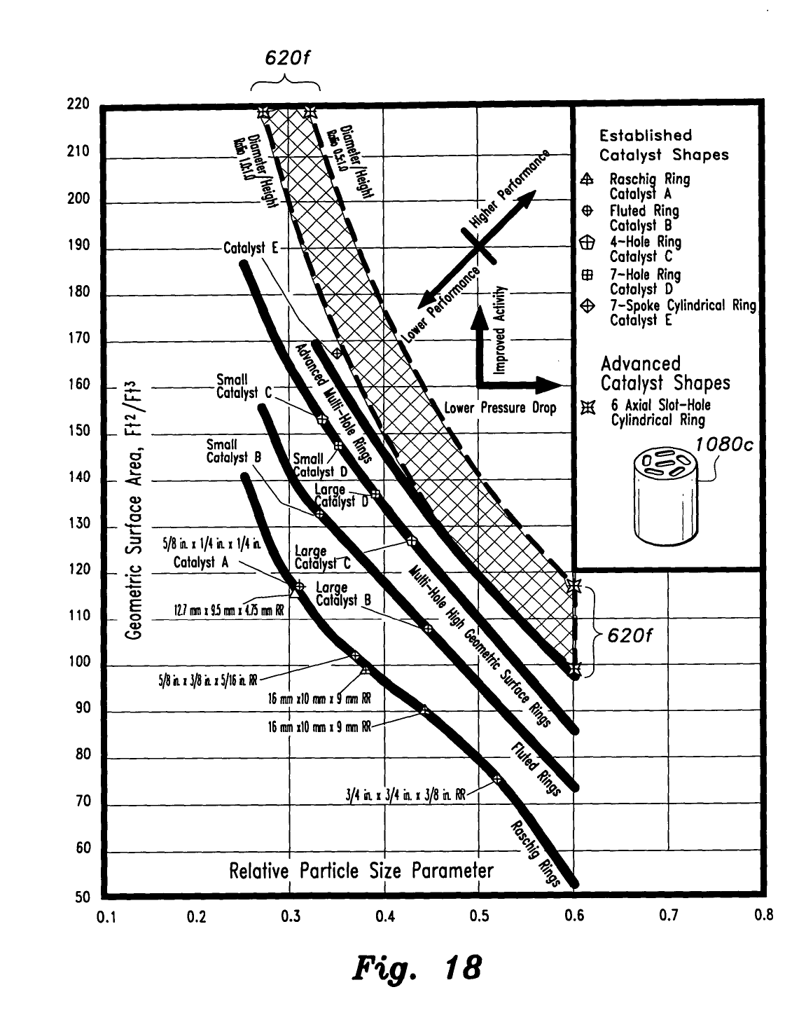

FIG. 18 shows a graph of GSA v. RPSP of the cylindrical ring catalyst 1080c with six internal generally slot-shaped holes 1100a, 1100b, 1100c, 1100d, 1000e and 1000f. The hatched area 620f indicates potential selections of the cylindrical ring catalyst 1080b with a diameter to height ratio in the range between about 0.5:1 to 1.0:1.0. The high performance catalyst particle 1080c has a higher Relative Particle Size Parameter (RPSP) and a Geometric Surface Area (GSA) for a particular RPSP than a prior art catalyst particle.

### EXAMPLE 7

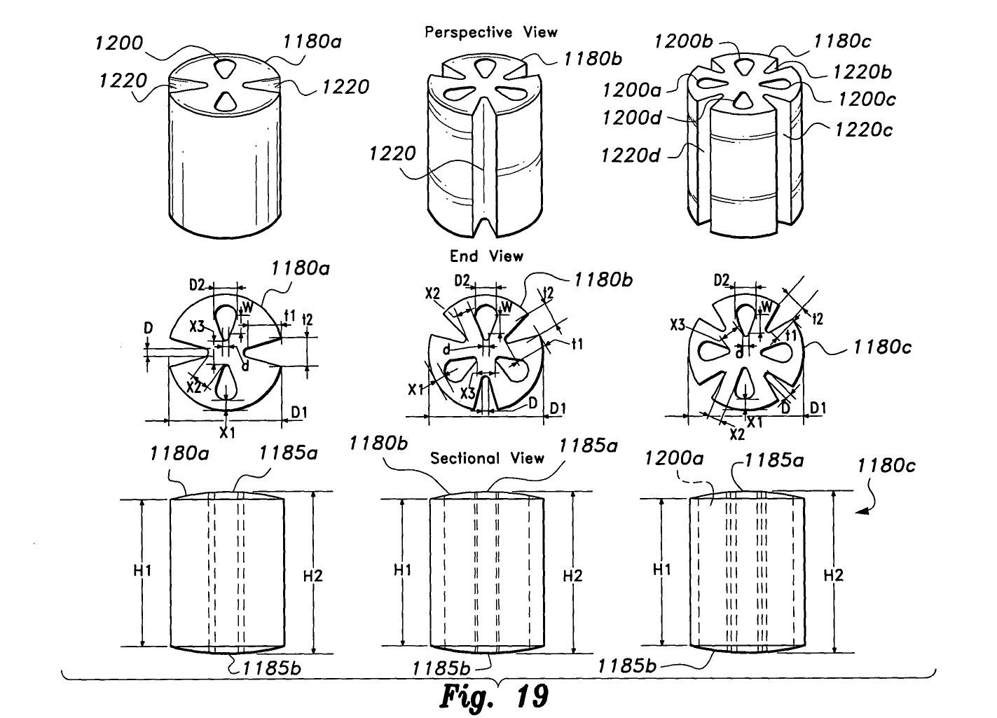

FIG. 19 shows separate perspective, top and bottom, and elevation views of cylindrical catalyst rings 1180 rings, and more specifically cylindrical catalyst rings 1180a, 1180b, and 1180c according to the present invention. The cylindrical catalyst ring 1180 may optionally defined curved or domed opposite ends 1185a and 1185b. More specifically, the ends 1185a and 1185b may be spherical, ellipsoidal or another curved shape, or may be flat and circular.

The rings 1180a, 1180b, and 1180c define at least one internal generally pear-shaped axial hole 1200 and at least one external slot hole 1220. For example, the cylindrical ring 1180c defines four internal generally pear-shaped axial holes 1200a, 1200b, 1200c, and 1200d, and four external slot holes 1220a 1220b, 1220c, and 1220d. The dimensions of the at least one pear-shaped axial hole 1200 are as described with respect to FIG. 7. It is preferred that the cylindrical ring 1180 defines at least three pear-shaped internal holes 1200 and at least three external slot holes 1220.

Still referring to FIG. 19, the pear-shaped and slot-shaped hole characteristic dimensions “d”, “W”, “D2”,“D”,“t1” and “t2” may be so altered as desired along with the number of holes 1200 to obtain an optimal hole pattern within the interior of the catalyst shape 1180 to achieve desired catalyst performance. The orientation of the pear-shaped holes 1200 arrangement may vary, being parallel or perpendicular to the radius from the central axis of the ring to the outer diameter or in other arrangements, depending on the number of pear-shaped holes 1200 selected, and catalyst strength or manufacturing issues. The advanced circular cylindrical catalyst shape 1180 has a preferred diameter to height ratio in the range of 0.5:1 to 2.0:1, and more preferably in the range of about 0.5:1 and 1.0:1.0.

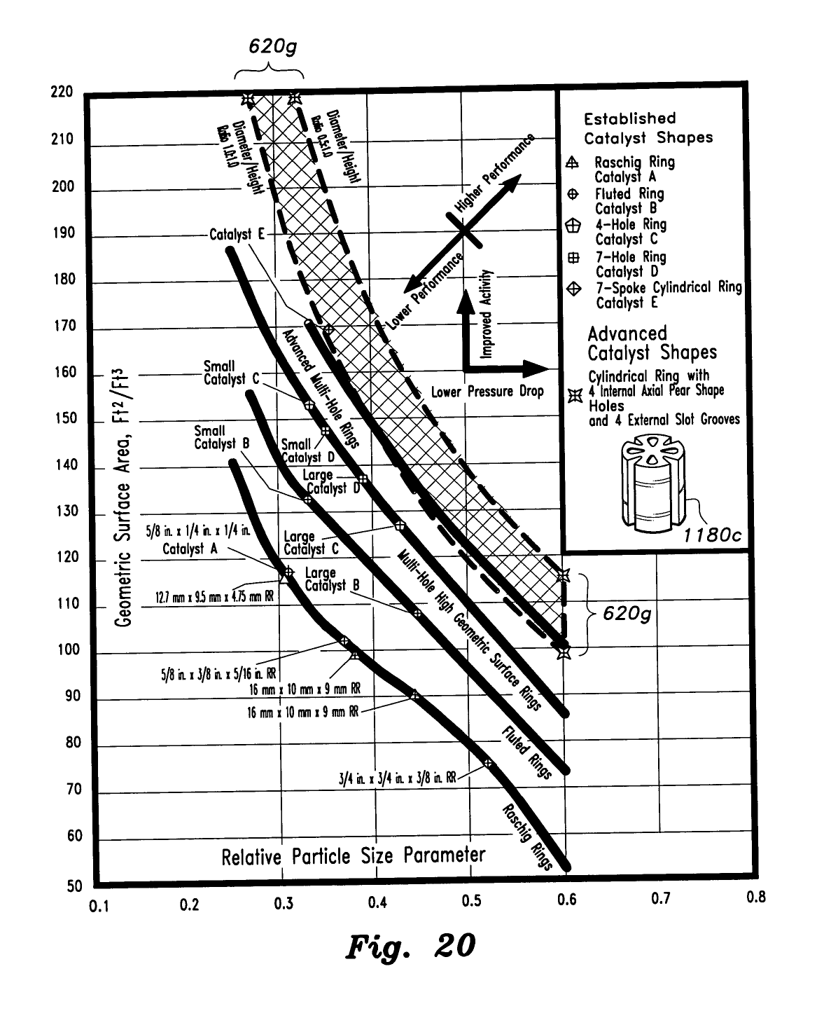

FIG. 20 shows a graph of GSA v. RPSP of the cylindrical ring catalyst 1180c with four internal generally pear-shaped axial holes 1200a, 1200b, 1200c, and 1200d, and four external slot holes 1220a 1220b, 1220c, and 1220d. The hatched area 620g indicates potential selections of the cylindrical ring catalyst 1180c with a diameter to height ratio in the range between about 0.5:1 to 1.0:1.0. The high performance catalyst particle 1180c has a higher Relative Particle Size Parameter (RPSP) and a Geometric Surface Area (GSA) for a particular RPSP than a prior art catalyst particle.

### EXAMPLE 8

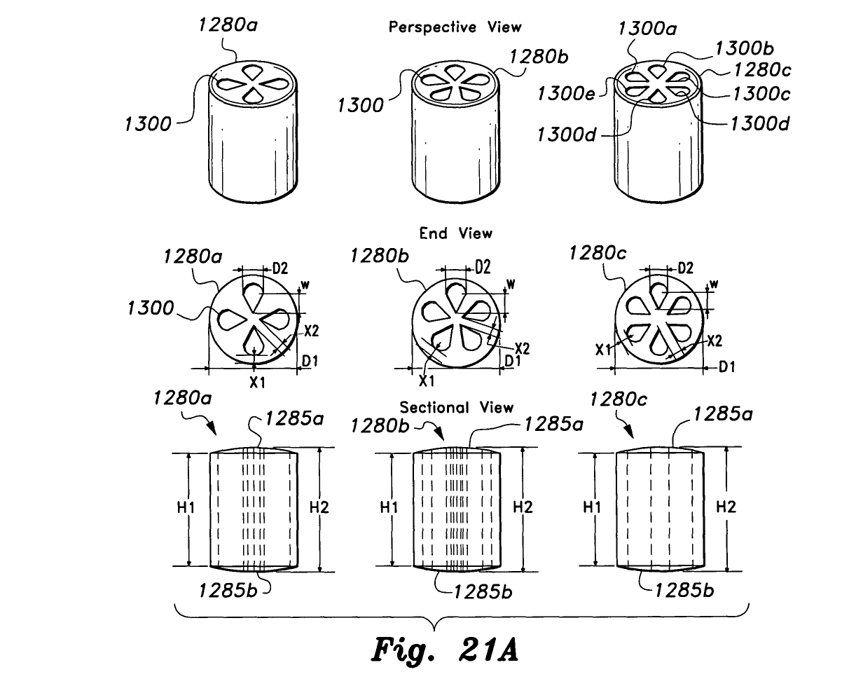

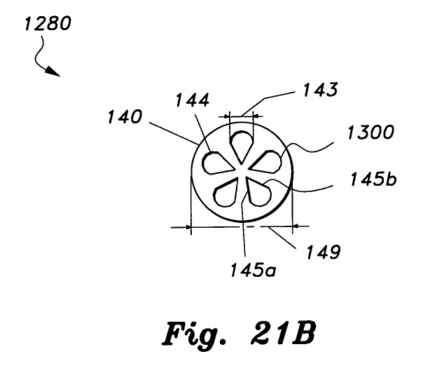

FIG. 21A shows separate perspective, top and bottom, and elevation views of cylindrical catalyst rings, and more specifically cylindrical catalyst rings 1280a, 1280b, and 1280c according to the present invention. The cylindrical catalyst ring 1280 may optionally defined curved or domed opposite ends 1285a and 1285b. More specifically, the ends 1285a and 1285b may be spherical, ellipsoidal or another curved shape, or may be flat and circular.

The rings 1280a, 1280b, and 1280c define at least one internal generally teardrop-shaped hole 1300. For example, the axial teardrop-shaped-holed cylindrical ring 1280c defines six generally teardrop-shaped holes 1300a, 1300b, 1300c, 1300d, 1300e and 1300f. It is preferred that the axial teardrop-shaped-holed cylindrical ring 1280 defines at least three generally teardrop-shaped holes 1300.

FIG. 21B shows a further top (or bottom) view of the catalyst shape 1280 having axial teardrop holes 1300. Each teardrop hole 1300 defines a curved end 144′ with characteristic width 143, opposite converging straight sides 145a′ and 145b′, and an outer diameter 149′. The curved end 144′ may be semi-circular or smaller portions of a circle, less than semi-circular, or instead may be formed as other curved shapes, including elliptical and fall within the scope of this invention.

Still referring to FIG. 21B, the teardrop-shaped hole characteristic dimensions of curved end 144′ and straight sides 145a′ and 145b′ may be so altered as desired along with the number of holes 1300 to obtain an optimal hole pattern within the interior of the catalyst shape 1280 to achieve desired catalyst performance. The orientation of the teardrop-shaped holes 1300 arrangement may vary, being parallel or perpendicular to the radius from the central axis of the ring to the outer diameter or in other arrangements, depending on the number of teardrop-shaped holes 1300 selected, and catalyst strength or manufacturing issues. The advanced circular cylindrical catalyst shape 1280 has a preferred diameter to height ratio in the range of 0.5:1 to 2.0:1, and more preferably in the range of about 0.5:1 and 1.0:1.0.

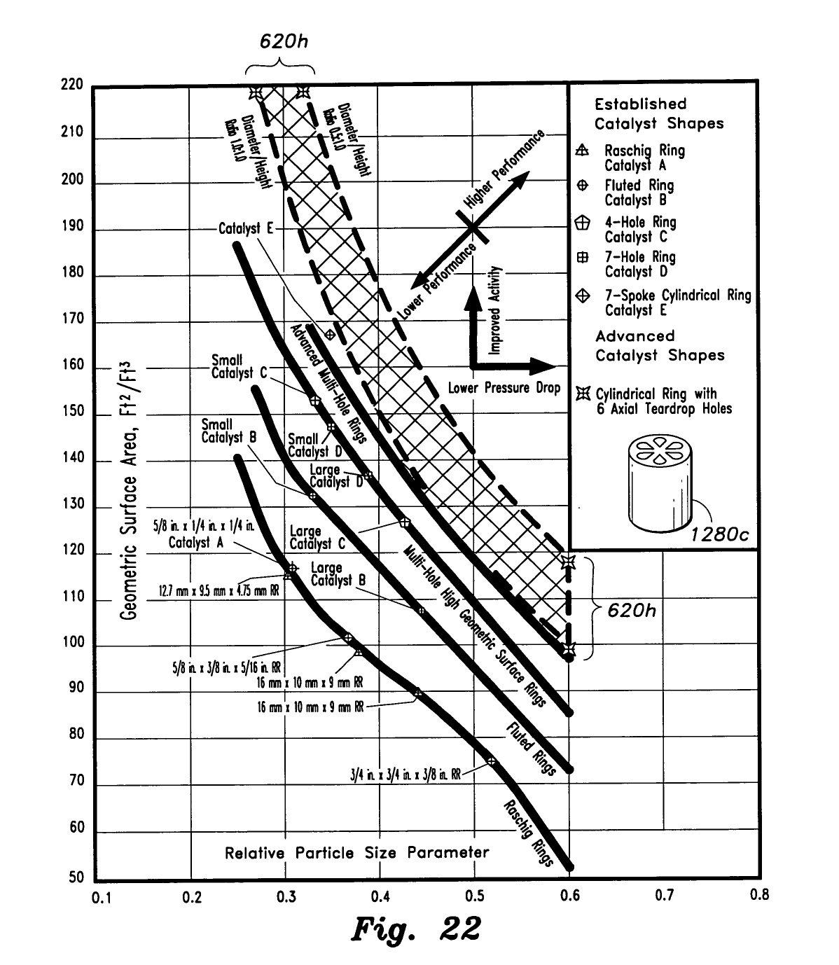

FIG. 22 shows a graph of GSA v. RPSP of the cylindrical ring catalyst 1280c with six generally teardrop-shaped holes 1300a, 1300b, 1300c, 1300d, 1300e and 1300f. The hatched area 620h indicates potential selections of the cylindrical ring catalyst 1280c with a diameter to height ratio in the range between about 0.5:1 to 2.0:1, and more particularly in the range between about 0.5:1 to 1.0:1.0. The high performance catalyst particle 1280c has a higher Relative Particle Size Parameter (RPSP) and a Geometric Surface Area (GSA) for a particular RPSP than a prior art catalyst particle.

The advanced catalyst shapes disclosed in Examples 1 through to Example 8 defines at least one axial hole with circular curves combined with straight edges to form closed elongated curved shapes which possess greater hole peripheral circumference than holes of circular or regular-polygon shapes of the prior art. In addition, the catalyst shapes of the present invention have equal or lesser hole cross sectional area than holes of circular or regular-polygon shapes of the prior art. The catalyst shapes of the present invention have a greater geometric surface area per catalyst unit volume than the prior art.

It should be noted that the above eight examples are non-limiting examples and should not be viewed as limiting the scope of the present invention. In addition, the invention includes other permutations that might be found in U.S. Provisional Patent Application Serial No. 60/402,580, filed Aug. 12, 2002. U.S. Provisional Patent Application Serial No. 60/402,580 is incorporated herein by reference in its entirety.

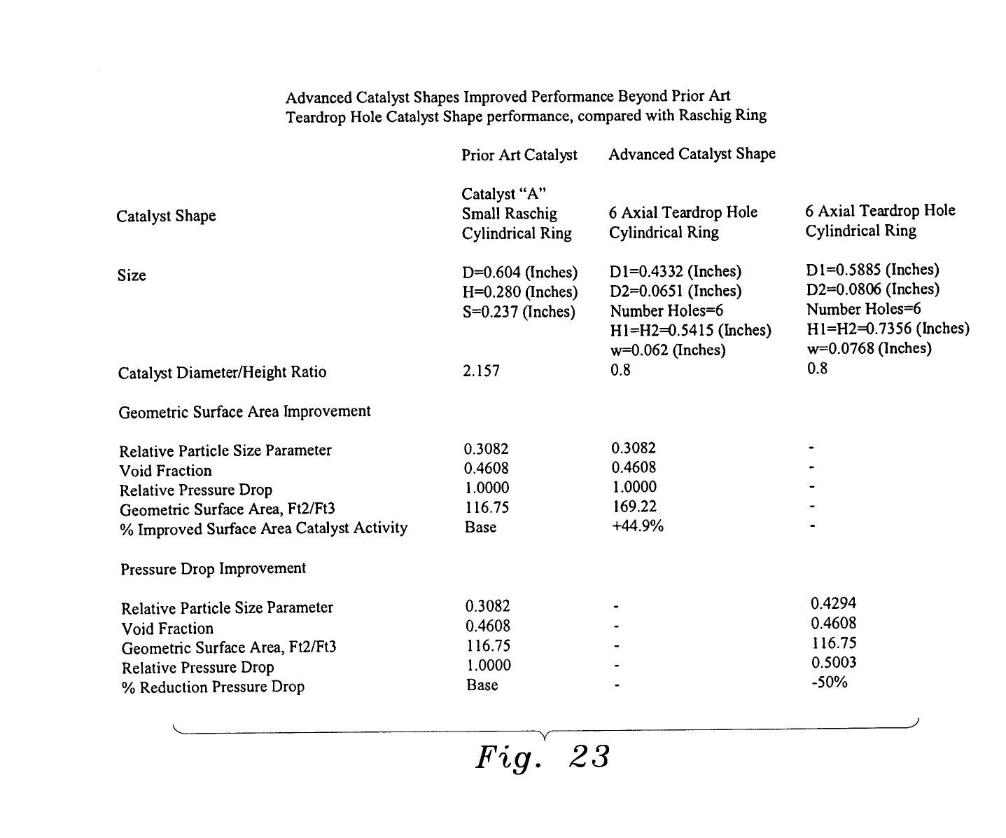

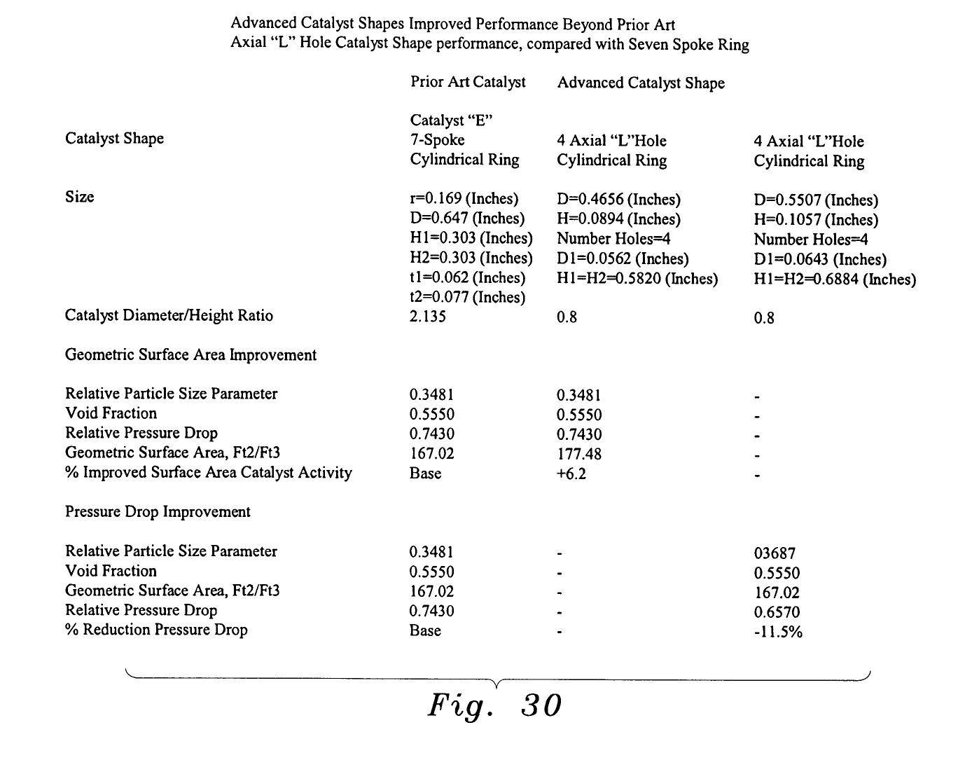

FIGS. 23 through to FIG. 30 compare the predicted catalytic performance of a range of cylindrical catalyst particles of the present invention with a variety of prior art catalyst particles. The presented data demonstrates the improved catalytic activity of the cylindrical catalyst particle of the present invention over the prior art.

With respect to the chemical constituents of the cylindrical catalysts of the present invention, non-limiting examples of compositions are shown in Tables 1 and 2. Generally, nickel is preferred as a cost-effective active catalytic constituent for promoting the Hydrocarbon Reforming reactions. However, other suitable catalytic constituents, which can be used alone or in combination, include: Cobalt, Lanthanum, Platinum, Palladium, Iridium, Rhodium, Rhenium, Ruthenium, Tin, Lead, Antimony, Bismuth, Germanium, Arsenic, Cerium, Cesium, Yttrium, Molybdenum, Copper, Zinc, Manganese, Chromium, Calcium, Titanium, Iron, Zirconium, Magnesium, Phosphorus, and Potassium.

For Heavy Hydrocarbon Reforming applications, promoters can be incorporated in the catalyst composition, including Potash or other Alkali-Compounds and Zirconium or Magnesium oxides to further improve catalyst activity. The active catalyst constituents are combined on and within various support substances, especially including Alumina, alpha-Alumina, Calcium-Aluminate, Magnesia-Alumina, Zirconia, Spinel, Thoria, Titania, Silica, Beryllia, Potash and other Alkali-earth compounds.

It should be understood that the cylindrical catalysts of the present invention are suitable for promoting chemical reactions other than Hydrocarbon Reforming reactions. For example, cylindrical catalysts of the present invention are suitable for aiding chemical reactions that are governed by the controlling steps of diffusion through gaseous film and/or absorbtion-desorbtion from active catalytic reaction sites.

It is to be understood that the present invention is not limited to the embodiments described above, but encompasses any and all embodiments within the scope of the following claims.

TABLE 1
Chemical Compositions for the Cylindrical Catalysts of
the Present Invention

| | | |
|---|---|---|
| | Composition 1 | Composition 2 |
| Ni | 0-25 Wt % | 0-20 Wt % |
| SiO₂ | 0-0.2 Wt % | 0-0.2 Wt % |
| Al₂O₃ | Balance | Balance |
| | Composition 3 | Composition 4 |
| Ni | 0-10 Wt % | 0-25 Wt % |
| SiO₂ | 0.2 Wt % | 0-0.2 Wt % |
| K₂O | | 0-2 Wt % |
| Al₂O_{3 Balance} | Balance | |
| | Composition 5 | Composition 6 |
| NiO | 0-20 Wt % | 0-10 Wt % |
| LaO | 0-5 Wt % | 0-5 Wt % |
| SiO₂ | 0-0.1 Wt % | 0-0.1 Wt % |
| Al₂O₃ | Balance | Balance |
| | Composition 7 | Composition 8 |
| NiO | 0-20 Wt % | 0-20 Wt % |
| SiO₂ | 0-0.1 Wt % | 0-0.1 Wt % |
| Al₂O₃ | Balance | — |
| K₂O | — | 0-2 Wt % |
| CaO/Al₂ O₃ | — | Balance |
| | Composition 9 | Composition 10 |
| NiO | 0-20 Wt % | 0-10 |
| SiO₂ | 0-0.2 Wt % | 0-0.1 Wt % |
| Na | — | 0-0.1 Wt % |
| K₂O | 0-2 Wt % | 0-0.1 Wt % |
| Mg Al₂O₄ | Balance | Balance |

TABLE 2
Chemical Compositions for the Cylindrical Catalysts of
the Present Invention

| | Composition 11 | Composition 12 | Composition 13 |
|---|---|---|---|
| Ni | 0-20 Wt % | 0-20 Wt % | 0-10 Wt % |
| SiO2 | — | 0-0.05 Wt % | 0-0.05 Wt % |
| C | 0-0.1 Wt % | 0-0.1 Wt % | — |
| Na | — | 0-0.15 Wt % | — |
| S | — | 0-0.05 Wt % | 0-0.05 Wt % |
| Cl | — | 0-0.02 Wt % | 0-0.02 Wt % |
| Al₂ O₃ | Balance | Balance | Balance |
| K₂O | 0-2 Wt % | — | — |
| CaO | 0-15 Wt % | — | — |

I claim:

1. An improved heterogeneous catalyst for catalyzing the reaction of gaseous reactants, comprising a high performance catalyst particle with a diameter to height ratio in the range between about 0.5:1 to 1.0:1.0, the high performance catalyst particle has a Relative Particle Size Parameter (RPSP) and a Geometric Surface Area (GSA), wherein the high performance catalyst particle has a higher GSA for a particular RPSP than a prior art catalyst particle.

2. The improved heterogeneous catalyst according to claim 1, wherein the heterogeneous catalyst particle is a cylindrical ring catalyst, wherein the cylindrical ring catalyst defines at least one internal axial pear-shaped hole.

3. The improved heterogeneous catalyst according to claim 1, wherein the heterogeneous catalyst particle is a cylindrical ring catalyst, wherein the cylindrical ring catalyst defines at least one internal axial elliptical hole.

4. The improved heterogeneous catalyst according to claim 1, wherein the heterogeneous catalyst particle is a cylindrical ring catalyst, wherein the cylindrical ring catalyst defines at least one internal axial L-shaped hole.

5. The improved heterogeneous catalyst according to claim 1, wherein the heterogeneous catalyst particle is a cylindrical ring catalyst, wherein the cylindrical ring catalyst defines at least one internal axial rounded diamond-shaped hole.

6. The improved heterogeneous catalyst according to claim 1, wherein the heterogeneous catalyst particle is a cylindrical ring catalyst, wherein the cylindrical ring catalyst defines at least one internal axial diamond-shaped hole.

7. The improved heterogeneous catalyst according to claim 1, wherein the heterogeneous catalyst particle is a cylindrical ring catalyst, wherein the cylindrical ring catalyst defines at least one axial internal slot-hole.

8. The improved heterogeneous catalyst according to claim 1, wherein the heterogeneous catalyst particle is a cylindrical ring catalyst, wherein the cylindrical ring catalyst defines at least one internal axial pear-shaped hole and at least one external slot hole.

9. The improved heterogeneous catalyst according to claim 1, wherein the heterogeneous catalyst particle is a cylindrical ring catalyst, wherein the cylindrical ring catalyst defines at least one internal axial teardrop hole.

10. The improved heterogeneous catalyst according to claim 1 further comprising, alone or in combination, the elements or oxides of the elements Nickel, Cobalt, Lanthanum, Platinum, Palladium, Iridium, Rhodium, Rhenium, Ruthenium, Tin, Lead, Antimony, Bismuth, Germanium, and Arsenic.

11. The improved heterogeneous catalyst according to claim 1 further comprising, alone or in combination, Potash or other Alkali-Compounds, Zirconium or Magnesium oxides, alpha-Alumina, Calcium-Aluminate, Magnesia-Alumina, Zirconia, and Spinel.

12. An improved heterogeneous catalyst for catalyzing the reaction of gaseous reactants, comprising a high performance catalyst particle with a diameter to height ratio in the range between about 0.5:1 to 1.0:1.0, the high performance catalyst particle has a Relative Particle Size Parameter (RPSP), a Geometric Surface Area (GSA), and an associated Relative Pressure Drop (RPD), wherein the high performance catalyst particle has a higher GSA for a particular RPSP or alternately a lower RPD for a particular GSA than a prior art catalyst particle.

13. The improved heterogeneous catalyst according to claim 12, wherein the heterogeneous catalyst particle is a cylindrical ring catalyst, wherein the cylindrical ring catalyst defines at least one internal axial pear-shaped hole.

14. The improved heterogeneous catalyst according to claim 12, wherein the heterogeneous catalyst particle is a cylindrical ring catalyst, wherein the cylindrical ring catalyst defines at least one internal axial elliptical-shaped hole.

15. The improved heterogeneous catalyst according to claim 12, wherein the heterogeneous catalyst particle is a cylindrical ring catalyst, wherein the cylindrical ring catalyst defines at least one internal axial L-shaped hole.

16. The improved heterogeneous catalyst according to claim 12, wherein the heterogeneous catalyst particle is a cylindrical ring catalyst, wherein the cylindrical ring catalyst defines at least one internal axial rounded diamond-shaped hole.

17. The improved heterogeneous catalyst according to claim 12, wherein the heterogeneous catalyst particle is a cylindrical ring catalyst, wherein the cylindrical ring catalyst defines at least one internal axial diamond-shaped hole.

18. The improved heterogeneous catalyst according to claim 12, wherein the heterogeneous catalyst particle is a cylindrical ring catalyst, wherein the cylindrical ring catalyst defines at least one internal axial slot-shaped hole.

19. The improved heterogeneous catalyst according to claim 12, wherein the heterogeneous catalyst particle is a cylindrical ring catalyst, wherein the cylindrical ring catalyst defines at least one internal axial pear-shaped hole and at least one external slot-shaped hole.

20. The improved heterogeneous catalyst according to claim 12, wherein the heterogeneous catalyst particle is a cylindrical ring catalyst, wherein the cylindrical ring catalyst defines at least one internal axial teardrop-shaped hole.

21. The improved heterogeneous catalyst according to claim 12, wherein the high performance catalyst particle is comprised, alone or in combination, of the elements or compounds of the elements Nickel, Cobalt, Lanthanum, Platinum, Palladium, Iridium, Rhodium, Rhenium, Ruthenium, Cerium, Cesium, Yttrium, Molybdenum, Copper, Zinc, Manganese, Chromium, Calcium, Titanium, Iron, Zirconium, Magnesium, Phosphorus, Potassium, Tin, Lead, Antimony, Bismuth, Germanium, Arsenic and compounds Alumina, alpha-Alumina, Calcium-Aluminate, Magnesia-Alumina, Zirconia, Spinel, Thoria, Titania, Silica, Beryllia, Potash or other Alkali-Compounds.

22. A cylindrical catalyst for catalyzing the reaction of gaseous reactants, wherein the cylindrical catalyst defines at least one axial hole with circular curves combined with straight edges to form closed elongated curved shapes which possess greater hole peripheral circumference than holes of circular or regular-polygon shapes of the prior art.

23. The improved heterogeneous catalyst according to claim 22, wherein the high performance catalyst particle is comprised, alone or in combination, of the elements or compounds of the elements Nickel, Cobalt, Lanthanum, Platinum, Palladium, Iridium, Rhodium, Rhenium, Ruthenium, Cerium, Cesium, Yttrium, Molybdenum, Copper, Zinc, Manganese, Chromium, Calcium, Titanium, Iron, Zirconium, Magnesium, Phosphorus, Potassium, Tin, Lead, Antimony, Bismuth, Germanium, Arsenic and compounds Alumina, alpha-Alumina, Calcium-Aluminate, Magnesia-Alumina, Zirconia, Spinel, Thoria, Titania, Silica, Beryllia, Potash or other Alkali-Compounds.
